(19) United States
(12) Patent Application Publication
(10) Pub. No.: US 2025/0307860 A1
(43) Pub. Date: Oct. 2, 2025

(54) METHODS AND APPARATUS TO DETECT ANOMALIES IN PRICE SERIES DATA

(71) Applicant: Nielsen Consumer LLC, Chicago, IL (US)

(72) Inventors: Silvia Duque, Valladolid (ES); Roberto Arroyo, Guadalajara (ES); José Javier Yebes Torres, Valladolid (ES)

(21) Appl. No.: 18/777,013

(22) Filed: Jul. 18, 2024

Related U.S. Application Data
(60) Provisional application No. 63/571,096, filed on Mar. 28, 2024.

(51) Int. Cl. G06Q 30/0201

(52) U.S. Cl. CPC G06Q 30/0206

(57) ABSTRACT

Methods and apparatus to detect anomalies in price series data are disclosed. An example apparatus includes at least one processor circuit to identify features in price series data, the price series data having a first quantity of data samples, execute, based on the identified features, an anomaly detection model to detect anomalies in the price series data, and generate a reduced report including a second quantity of the data samples corresponding to the detected anomalies, the second quantity less than the first quantity, a difference between the first quantity and the second quantity corresponding to an omitted portion of the price series data.

### RELATED APPLICATION

This patent claims the benefit of U.S. Provisional Patent Application No. 63/571,096, titled “METHODS AND APPARATUS TO DETECT ANOMALIES IN PRICE SERIES DATA,” which was filed on Mar. 28, 2024. U.S. Provisional Patent Application No. 63/571,096 is hereby incorporated herein by reference in its entirety. Priority to U.S. Provisional Patent Application No. 63/571,096 is hereby claimed.

### FIELD OF THE DISCLOSURE

This disclosure relates generally to data processing and, more particularly, to methods and apparatus to detect anomalies in price series data.

### BACKGROUND

Market data, such as price series data, can be collected, analyzed, and stored in a database. The price series data may be utilized by advertisers and/or retailers to inform marketing activities, perform trend forecasting, evaluate product performance, etc. Some database proprietors can update and/or adjust the price series data stored in the database based on updated pricing information from retailers, changing economic conditions, etc.

### BRIEF DESCRIPTION OF THE DRAWINGS

FIG. 1 illustrates an example environment in which example anomaly detection circuitry can be implemented in accordance with teachings of this disclosure.

FIG. 2 is a block diagram of an example implementation of the anomaly detection circuitry of FIG. 1.

FIG. 3 is a first example process flow representative of an example model training process to generate and/or train one or more example anomaly detection models to be implemented by the anomaly detection circuitry of FIGS. 1 and/or 2.

FIG. 4 is a second example process flow to perform the model training process of FIG. 3.

FIG. 5 is a third example process flow representative of an example anomaly detection process to be implemented by the anomaly detection circuitry of FIGS. 1 and/or 2.

FIG. 6 illustrates a first example reduced report that may be generated by the anomaly detection circuitry of FIGS. 1 and/or 2.

FIG. 7 illustrates a second example reduced report that may be generated by the anomaly detection circuitry of FIGS. 1 and/or 2.

FIG. 8A illustrates first and second example graphs representative of example distributions of first data samples corresponding to a first example geographic region.

FIG. 8B illustrates third and fourth example graphs representative of example distributions of second data samples corresponding to a second example geographic region.

FIG. 9A illustrates a first example table representative of first example performance metrics corresponding to the first geographic region.

FIG. 9B illustrates a second example table representative of second example performance metrics corresponding to the second geographic region.

FIG. 10 illustrates an example table comparing example performance metrics obtained using respective different machine learning models.

FIG. 11 illustrates a first example graph representative of example training durations corresponding to respective different machine learning models.

FIG. 12 illustrates a second example graph representative of example prediction durations corresponding to respective different machine learning models.

FIG. 13 illustrates an example table representative of an example forward approach for feature selection for the one or more anomaly detection models to be implemented by the anomaly detection circuitry of FIGS. 1 and/or 2.

FIG. 14A is a flowchart representative of example machine readable instructions and/or example operations that may be executed, instantiated, and/or performed by programmable circuitry to detect anomalies in example price series data.

FIG. 14B is a flowchart representative of example machine readable instructions and/or example operations that may be executed, instantiated, and/or performed by programmable circuitry to monitor report transmission requests.

FIG. 15 is a flowchart representative of example machine readable instructions and/or example operations that may be executed, instantiated, and/or performed by programmable circuitry to generate and/or train one or more example anomaly detection models.

FIG. 16 is a flowchart representative of example machine readable instructions and/or example operations that may be executed, instantiated, and/or performed by programmable circuitry to determine example performance metrics corresponding to a selected combination of candidate hyperparameter values.

FIG. 17 is a block diagram of an example processing platform including programmable circuitry structured to execute, instantiate, and/or perform the example machine readable instructions and/or perform the example operations of FIGS. 14A, 14B, 15, and/or 16 to implement the anomaly detection circuitry of FIG. 2.

FIG. 18 is a block diagram of an example implementation of the programmable circuitry of FIG. 17.

FIG. 19 is a block diagram of another example implementation of the programmable circuitry of FIG. 17.

FIG. 20 is a block diagram of an example software/firmware/instructions distribution platform (e.g., one or more servers) to distribute software, instructions, and/or firmware (e.g., corresponding to the example machine readable instructions of FIGS. 14A, 14B, 15, and/or 16) to client devices associated with end users and/or consumers (e.g., for license, sale, and/or use), retailers (e.g., for sale, re-sale, license, and/or sub-license), and/or original equipment manufacturers (OEMs) (e.g., for inclusion in products to be distributed to, for example, retailers and/or to other end users such as direct buy customers).

In general, the same reference numbers will be used throughout the drawing(s) and accompanying written description to refer to the same or like parts. The figures are not necessarily to scale. Instead, the thickness of the layers or regions may be enlarged in the drawings. Although the figures show layers and regions with clean lines and boundaries, some or all of these lines and/or boundaries may be idealized. In reality, the boundaries and/or lines may be unobservable, blended, and/or irregular.

### DETAILED DESCRIPTION

Market data, such as price series data, is often collected, analyzed, and stored in one or more databases for use in various applications (e.g., marketing, product development, trend forecasting, materials sourcing scheduling, delivery dispatch scheduling and control, etc.). Such price series data may include data samples corresponding to respective different products, geographic regions, and/or retailers. For instance, the data samples can represent product information such as prices and/or product descriptions associated with the respective products. Some database proprietors generate the price series data by accessing and/or obtaining product information from retailers of the respective products, then generating and/or updating corresponding entries (e.g., data samples) in a database. In some examples, price series data includes tens of thousands of data points (or more) related to retailers having a large regional and/or global presence. Further, the database proprietors can obtain (e.g., periodically) new and/or updated product information from the retailers to evaluate trends in prices over time. For instance, a retailer price (e.g., a current price, a ground truth price) obtained from a retailer for a given product may vary significantly (e.g., by at least a threshold amount) from a reference price (e.g., a database price) stored in the database for that product. Such variation may indicate to the database proprietor that the reference price stored in the database is inaccurate and, thus, should be manually reviewed and/or adjusted.

Variations between retailer prices and reference prices for respective products can occur for many reasons. For instance, some price variations are expected when they occur as a result of a change in economic conditions (e.g., inflation), a promotion (e.g., temporary price reduction, buy-one-get-one (BOGO) promotion, etc.), and/or a change in one or more characteristics (e.g., size, packaging, quantity, etc.) associated with the respective product. Additionally or alternatively, prices are expected to vary between retailers, geographic regions, times of year (e.g., prices of cold-weather products in summer compared to winter), etc. In other instances, price variations may be unexpected, unintended, and/or otherwise correspond to an anomaly. As used herein, an anomaly refers to an unexpected and/or unintended variation between a retailer price and a reference price for a given product. Such anomalous prices may result from errors in computer code associated with the database, and/or may result from human error when inputting product information into the database. As used herein, a price exception refers to a data sample for which the retailer price varies (e.g., differs) significantly (e.g., by more than a threshold amount) from the reference price. As such, an anomaly is a type of price exception for which the price variation is unexpected and/or unintended.

In some instances, expected (e.g., non-anomalous) price exceptions do not necessitate action (e.g., correction, adjustment) and/or may otherwise be ignored. Conversely, unexpected (e.g., anomalous) price exceptions may necessitate further review and/or correction. Typically, anomalous price exceptions are indistinguishable from non-anomalous price exceptions based on price alone. Instead, a combination of factors associated with a respective product (e.g., product description, retailer and/or reference prices, etc.) may influence whether a price exception corresponds to an anomaly. As such, manual (e.g., human) review of price exceptions is typically performed to identify and/or correct anomalies in price series data. For instance, data samples corresponding to price exceptions (e.g., price variations greater than a threshold) are selected from the price series data and used to generate a price exception report. The price exception report is then manually reviewed (e.g., by a human) to distinguish (e.g., differentiate) between anomalous and non-anomalous price exceptions. However, some price exception reports can contain large quantities of price exceptions (e.g., thousands, tens of thousands, millions, etc.) that necessitate review. As a result, manual review of such price exception reports is often time-consuming, prone to human error, and/or otherwise inefficient. Additionally, price exception reports with large quantities of price exceptions may utilize significant computational resources (e.g., memory, power consumption, heat generation and/or bandwidth congestion) for transmission and/or storage.

Examples disclosed herein facilitate detection of anomalies in price series data. For example, example anomaly detection circuitry disclosed herein can generate, train, and/or execute one or more example machine learning models (e.g., anomaly detection model(s), anomaly detection neural network(s)) based on a subset of features identified in the price series data. In some examples, the machine learning model(s) can include one or more binary decision trees trained based on historical data. As a result of the execution of the machine learning model(s), the anomaly detection circuitry can output predicted labels to indicate whether respective data samples in the price series data are anomalous or non-anomalous. In some examples, the anomaly detection circuitry can output one or more example reports (e.g., reduced reports, reduced price exception reports) based on the detected anomalies. For example, the report(s) can include first one(s) of the data samples corresponding to an anomalous predicted label, and/or can omit second one(s) of the data samples corresponding to a non-anomalous predicted label. As a result, the price series data includes a first quantity of data samples, and the report(s) include a second quantity of data samples, where the second quantity of data samples is less than (e.g., less than 1 percent of) the first quantity of data samples. Accordingly, transmission of the second quantity of data samples for review purposes consumes substantially less network bandwidth than would otherwise occur, thereby saving energy, saving storage space, and reducing network equipment heat generation.

In some examples, the report(s) can be reviewed (e.g., manually reviewed) by one or more operators (e.g., human(s)) to distinguish between true positives (e.g., data samples that were correctly predicted to be anomalous and that necessitate action and/or correction) and false positives (e.g., data samples that were incorrectly predicted to be anomalous and that do not necessitate action and/or correction). In some examples, by generating the reduced report(s) based on the price series data, the anomaly detection circuitry reduces the quantity of data samples (e.g., relative to the first quantity of data samples included in the price series data) to be manually reviewed and, thus, reduces an amount of time necessitated to perform the review. For example, while known techniques for generating price exception reports typically select data samples for review based on a single variable and/or feature (e.g., a difference between the reference price and retailer price), disclosed examples evaluate multiple features (e.g., a subset of features) to more accurately differentiate between anomalous and non-anomalous data samples and, as a result, reduce the number of data samples to be reviewed (e.g., compared to the known techniques for generating price exception reports). Stated differently, known techniques that enjoy the benefits of robust and/or otherwise high speed capabilities still suffer excess energy consumption, heat generation and/or network bandwidth congestion that examples disclosed herein reduce. Accordingly, green energy initiatives are realized by examples disclosed herein.

Further, as a result of the reduction in the quantity of data samples, the report(s) can utilize fewer computational resources (e.g., computer memory and/or bandwidth) for storage and/or transmission of the report(s) (e.g., compared to the price series data and/or compared to price exception reports generated using known techniques). Additionally, by utilizing machine learning model(s) based on a binary decision tree, examples disclosed herein can be executed on a central processing unit (CPU) (e.g., in addition to or instead of a graphics processing unit (GPU)), thus necessitating fewer computational resources compared to when other machine learning models are used.

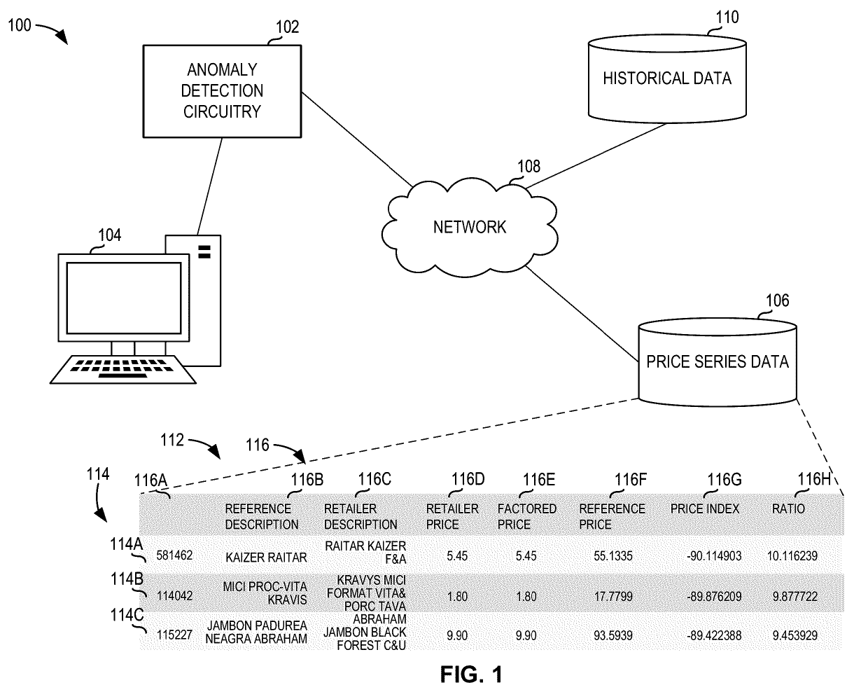

FIG. 1 illustrates an example environment 100 in which example anomaly detection circuitry 102 can be implemented in accordance with teachings of this disclosure. In the illustrated example of FIG. 1, the anomaly detection circuitry 102 is implemented on an example user device (e.g., an electronic device) 104. In this example, the user device 104 is a computer, but can be implemented as any other type of electronic computing device, including a laptop, a server, an edge network device, etc.

In the illustrated example of FIG. 1, the anomaly detection circuitry 102 can access, obtain, and/or receive example price series data 106 and example historical data (e.g., historical price series data) 110 via an example network 108. In some examples, the price series data 106 and/or the historical data 110 is preloaded in the anomaly detection circuitry 102. In the example of FIG. 1, the price series data 106 includes prices and/or other product information associated with one or more respective products. In some examples, the price series data 106 is generated based on information from one or more retailers of the respective products. The price series data 106 can be collected and/or maintained in one or more example databases by a database proprietor.

An example table 112 representative of the price series data 106 (or a portion thereof) is shown in FIG. 1. For example, the table 112 includes example rows 114 (e.g., including a first example row 114A, a second example row 114B, and a third example row 114C) corresponding to respective different products. Stated differently, the rows 114 correspond to respective different data samples of the price series data 106. Further, the table 112 includes example columns 116 (e.g., including a first example column 116A, a second example column 116B, a third example column 116C, a fourth example column 116D, a fifth example column 116E, a sixth example column 116F, a seventh example column 116G, and an eighth example column 116H) corresponding to respective different example features (e.g., variables, characteristics) associated with the respective products and/or data samples.

In the illustrated example of FIG. 1, the first column 116A represents example identifiers (e.g., product identifiers) corresponding to the products represented in the respective rows 114. The second column 116B represents example reference descriptions (e.g., reference product descriptions, reference description features) corresponding to the products represented in the respective rows 114. In some examples, the reference descriptions are generated and/or selected (e.g., by a user) based on combinations of descriptions obtained from multiple retailers. The third column 116C represents example retailer descriptions (e.g., retailer product descriptions, retailer description features) corresponding to the products represented in the respective rows 114. In some examples, the retailer descriptions in the third column 116C are provided by and/or obtained from retailer(s) of the respective products. The fourth column 116D represents example retailer prices (e.g., retailer price features) corresponding to the products represented in the respective rows 114. In some examples, the retailer prices are provided by and/or obtained from the retailer(s) of the respective products. The fifth column 116E represents example factored prices (e.g., factored price features) corresponding to the products in the respective rows 114. In some examples, the factored prices in the fifth column 116E are determined by multiplying the retailer prices in the fourth column 116D by an example correction factor. For example, the correction factor may be generated and/or selected manually (e.g., based on user input). The sixth column 116F represents example reference prices (e.g., reference price features) corresponding to the products in the respective rows 114. In some examples, the reference prices in the sixth column 116F are determined by the database proprietor based on retailer prices across multiple retailers, geographic regions, etc. For example, the reference price for a given product corresponds to a median value across the multiple retailer prices for that product. In some examples, the reference price corresponds to a different statistical value (e.g., average, minimum, maximum, etc.) across the multiple retailer prices.

The seventh column 116G represents an example price index feature corresponding to a difference (e.g., a percentage change, a percentage difference) between the factored price (e.g., represented in the fifth column 116E) and the reference price (e.g., represented in the sixth column 116F) for respective products. In some examples, the price index feature can be determined based on example Equation 1 below.

$$PRICE INDEX = \frac{FACTORED PRICE - REFERENCE PRICE}{REFERENCE PRICE} \qquad ( Equation 1 )$$

In example Equation 1 above, FACTORED PRICE represents the factored price (e.g., from the fifth column 116E) for a respective product, REFERENCE PRICE represents the reference price (e.g., from the sixth column 116F) for the respective product, and PRICE INDEX represents the price index feature. The eighth column 116H represents example ratios between the factored prices (e.g., represented in the fifth column 116E) and the reference prices (e.g., represented in the sixth column 116F) for respective products. For example, the ratios in the eighth column 116H can be determined by dividing the reference prices by the factored prices for the respective products.

In the illustrated example of FIG. 1, the table 112 includes three of the rows 114 corresponding to respective different products. In some examples, the table 112 can include a different number of the rows 114 (e.g., one, two, four or more) instead. Further, while eleven of the columns 116 are included in the table 112 of FIG. 1, one or more of the columns 116 of FIG. 1 may be omitted in some examples. In some examples, one or more additional columns (e.g., corresponding to respective different example features) may be included in the table 112.

For example, the price series data 106 (e.g., as represented by the table 112) can include first example binary values (e.g., applied factor features) representative of whether a correction factor has been applied to the retailer prices (e.g., from the fourth column 116D) for respective ones of the products. In some examples, the price series data 106 can include second example binary values (e.g., suggested factor features) representative of whether a correction factor is available (e.g. whether a correction factor has been suggested and/or determined) for respective ones of the products. In some examples, the price series data 106 can include differences (e.g., a percentage differences) between the retailer prices (e.g., from the fourth column 116D) and the reference prices (e.g., from the sixth column 116F) for respective ones of the products. For example, the difference between the retailer price and the reference price for a given product can be determined based on example Equation 2 below.

$$PREVIOUS PRICE INDEX = \frac{RETAILER PRICE - REFERENCE PRICE}{REFERENCE PRICE} \qquad ( Equation 2 )$$

In example Equation 2 above, RETAILER PRICE represents the retailer price (e.g., from the fourth column 116D) for a respective product, REFERENCE PRICE represents the reference price (e.g., from the sixth column 116F) for the respective product, and PREVIOUS PRICE INDEX represents the difference between the retailer price and the reference price.

In some examples, the price series data 106 can include, for a respective product, a first example percentage difference between the factored price (e.g., from the fifth column 116E) and the reference price (e.g., from the sixth column 116F) relative to an average of the factored price and the reference price. For example, the first percentage difference can be determined based on example Equation 3 below.

$$PERCENTAGE DIFFERENCE = \frac{FACTORED PRICE - REFERENCE PRICE}{( FACTORED PRICE + REFERENCE PRICE ) / 2} \times 100 \qquad ( Equation 3 )$$

In example Equation 3 above, FACTORED PRICE represents the factored price (e.g., from the fifth column 116E) for a respective product, REFERENCE PRICE represents the reference price (e.g., from the sixth column 116F), and PERCENTAGE DIFFERENCE represents the first percentage difference between the factored and reference prices relative to an average of the factored and reference prices.

In some examples, the price series data 106 can include, for a respective product, a second example percentage difference between the retailer price (e.g., from the fourth column 116D) and the reference price (e.g., from the sixth column 116F) relative to an average of the retailer price and the reference price. For example, the second percentage difference can be determined based on example Equation 4 below.

$$PREVIOUS PERCENTAGE DIFFERENCE = \frac{RETAILER PRICE - REFERENCE PRICE}{( RETAILER PRICE + REFERENCE PRICE ) / 2} \times 100 \qquad ( Equation 4 )$$

In example Equation 4 above, RETAILER PRICE represents the retailer price (e.g., from the fourth column 116D) for a respective product, REFERENCE PRICE represents the reference price (e.g., from the sixth column 116F), and PREVIOUS PERCENTAGE DIFFERENCE represents the second percentage difference between the retailer and reference prices relative to an average of the retailer and reference prices.

In some examples, the price series data 106 includes a third example binary value representative of whether a first difference (e.g., the first percentage difference) between the factored price and the reference price is greater than a second difference (e.g., the second percentage difference) between the retailer price and the reference price. For example, the third binary value can be determined by calculating the first difference based on example Equation 3 above and calculating the second difference based on example Equation 4 above, then determining whether the first difference is greater than the second difference. In some examples, the price series data 106 includes example dummy variables for respective different retailers in a corresponding geographic region.

In some examples, the price series data 106 can include one or more additional example features associated with the descriptions (e.g., the retailer descriptions and/or the reference descriptions) corresponding to the respective products. For example, the price series data 106 can include, for a respective product, an example common word count corresponding to a number of common words between the retailer description and the reference description. In some examples, the price series data 106 can include, for a respective product, a fourth example binary value representative of whether at least one of the retailer description or the reference description includes a numerical value. In some examples, the price series data 106 includes, for a respective product, a fifth example binary value representative of whether at least one of the retailer description or the reference description includes the correction factor. In some examples, the price series data 106 includes, for a respective product, an example distance value representative of a normalized Levenshtein distance between the retailer description and the reference description.

In the illustrated example of FIG. 1, the anomaly detection circuitry 102 generates, trains, and/or executes one or more example anomaly detection models (e.g., anomaly detection machine learning model(s), anomaly detection neural network model(s)) to detect anomalies in the price series data 106. For example, the anomaly detection circuitry 102 identifies one or more example features (e.g., data features, variables) represented in the price series data 106, and executes the anomaly detection model(s) based on the identified features. In some examples, as a result of the execution, the anomaly detection circuitry 102 detects and/or identifies one(s) of the data samples of the price series data 106 (e.g., one(s) of the rows 114 of the table 112 of FIG. 1) that correspond to an anomaly. In some examples, the anomaly detection circuitry 102 generates one or more example reports (e.g., price exception report(s), reduced report(s)) based on the identified data samples. For example, the report(s) can include the identified data samples (e.g., the identified rows 114) corresponding to an anomaly, and can omit (e.g., do not include) remaining ones of the data samples that do not correspond to an anomaly (e.g., are non-anomalous). Stated differently, the price series data 106 includes a first quantity of data samples, and the report(s) can include a second quantity of data samples (e.g., less than the first quantity of data samples). Further, a difference between the first quantity and the second quantity corresponds to an omitted portion of the price series data 106, where the omitted portion does not correspond to (e.g., omits) the anomalous data samples. In some examples, the anomaly detection circuitry 102 can output the report(s) for presentation (e.g., by the user device 104) to a user. In some examples, the report(s) can be reviewed (e.g., manually reviewed by the user) to identify and/or differentiate between true positives (e.g., data samples that necessitate action and/or correction) and false positives (e.g., data samples that do not necessitate action and/or correction).

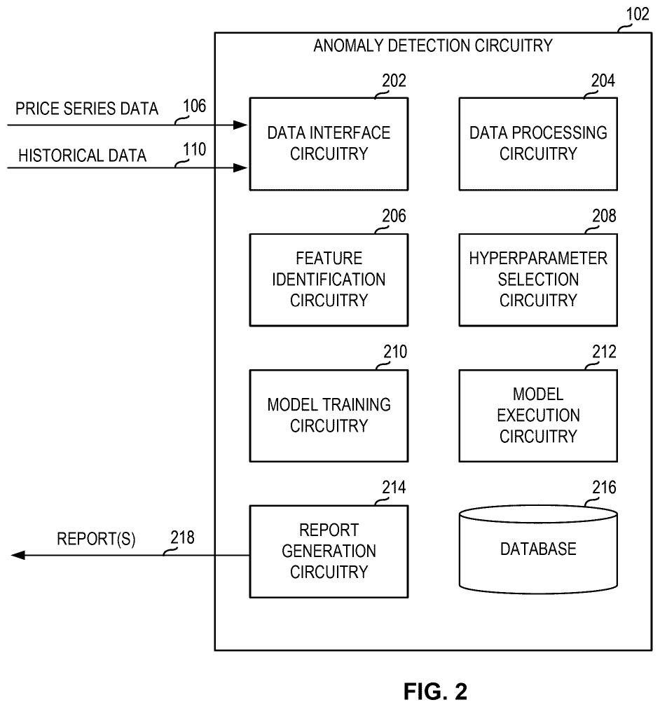

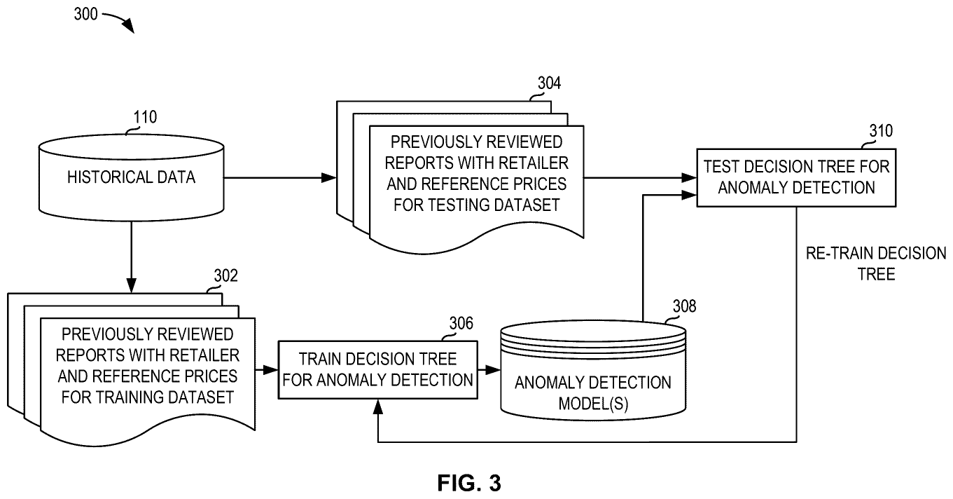

In some examples, the anomaly detection circuitry 102 generates and/or trains the anomaly detection model(s) based on the historical data 110. For example, the historical data 110 can include historical price exception reports representative of historical data samples and associated labels (e.g., ground truth labels), where the labels indicate whether the corresponding data samples are true positives (e.g., anomalous data samples) or false positives (e.g., non-anomalous data samples). In some examples, the historical data 110 is represented in a table format (e.g., similar to the table 112 shown in FIG. 2 for the price series data 106), and can include one or more columns to represent the labels corresponding to the respective historical data samples. In some examples, the labels are selected based on results of manual review of the historical exception reports. In some examples, the anomaly detection circuitry 102 generates and/or trains the anomaly detection model(s) by identifying pattern(s) between features of the historical data samples and the respective labels, then adjusting and/or selecting parameters (e.g., weights, hyperparameters, etc.) of the anomaly detection model(s) based on the identified pattern(s). Generation and/or training of the anomaly detection model(s) is described further below in connection with FIGS. 3 and/or 4.

Artificial intelligence (AI), including machine learning (ML), deep learning (DL), and/or other artificial machine-driven logic, enables machines (e.g., computers, logic circuits, etc.) to use a model to process input data to generate an output based on patterns and/or associations previously learned by the model via a training process. For instance, the model may be trained with data to recognize patterns and/or associations and follow such patterns and/or associations when processing input data such that other input(s) result in output(s) consistent with the recognized patterns and/or associations.

Many different types of machine learning models and/or machine learning architectures exist. In examples disclosed herein, a binary decision tree model (e.g., a binary classification decision tree model, a binary classification neural network) is used. In some examples, using a binary decision tree model enables execution of the machine learning model(s) on a CPU (e.g., in addition to or instead of a GPU). In general, machine learning models/architectures that are suitable to use in the example approaches disclosed herein will be neural networks. However, other types of machine learning models could additionally or alternatively be used (e.g., a random forest model, a gradient boosting model, a support vector machine model, a XGBoost model, a linear regression model, a lasso regression model, a ridge regression model, a K-nearest neighbors model, etc.).

In general, implementing a ML/AI system involves two phases, a learning/training phase and an inference phase. In the learning/training phase, a training algorithm is used to train a model to operate in accordance with patterns and/or associations based on, for example, training data. In general, the model includes internal parameters that guide how input data is transformed into output data, such as through a series of nodes and connections within the model to transform input data into output data. Additionally, hyperparameters are used as part of the training process to control how the learning is performed (e.g., a learning rate, a number of layers to be used in the machine learning model, etc.). Hyperparameters are defined to be training parameters that are determined prior to initiating the training process.

Different types of training may be performed based on the type of ML/AI model and/or the expected output. For example, supervised training uses inputs and corresponding expected (e.g., labeled) outputs to select parameters (e.g., by iterating over combinations of select parameters) for the ML/AI model that reduce model error. As used herein, a label refers to an expected output of the machine learning model (e.g., a classification, an expected output value, etc.) Alternatively, unsupervised training (e.g., used in deep learning, a subset of machine learning, etc.) involves inferring patterns from inputs to select parameters for the ML/AI model (e.g., without the benefit of expected (e.g., labeled) outputs).

In examples disclosed herein, ML/AI models are trained based on decision trees (e.g., binary decision trees). However, any other suitable training algorithm may additionally or alternatively be used. In examples disclosed herein, training is performed until an acceptable amount of error is achieved (e.g., until a recall metric and/or an accuracy metric associated with the ML/AI model(s) satisfy corresponding thresholds). In examples disclosed herein, training can be performed locally (e.g., at the user device 104 of FIG. 1) and/or remotely (e.g., in a cloud-based environment, at a remote device communicatively coupled to the user device 104 via the network 108, etc.). Training is performed using hyperparameters that control how the learning is performed (e.g., a learning rate, a number of layers to be used in the machine learning model, etc.). In examples disclosed herein, the hyperparameters can include a threshold depth associated with the binary decision tree, a first threshold number of samples to split an internal node of the binary decision tree, a second threshold number of samples corresponding to a leaf node of the binary decision tree, and/or or first and second weights associated with respective first and second classes to be predicted based on the binary decision tree. In some examples, the hyperparameters are selected based on user input and/or are selected from combinations of candidate hyperparameter values (e.g., based on performance metrics associated with the respective combinations). In some examples, re-training may be performed. Such re-training may be performed in response to a recall metric associated with the model not satisfying a recall threshold (e.g., 90 percent (%), 95%, 98%, 99%, etc.).

Training is performed using training data. In examples disclosed herein, the training data originates from the historical data 110 including historical price exception reports. Because supervised training is used, the training data is labeled. For example, the historical data 110 includes labels for respective data samples in the historical price exception reports, where the labels indicate whether the respective data samples correspond to an anomaly. Labeling can be applied to the training data by a user based on manual review of the historical price exception reports to identify the anomalies (e.g., anomalous data samples) therein. In some examples, the training data is pre-processed to remove duplicates from the data samples and/or to identify (e.g., calculate, determine) one or more features of the data samples. In some examples, the training data is sub-divided into training data and validation data.

Once training is complete, the model is deployed for use as an executable construct that processes an input and provides an output based on the network of nodes and connections defined in the model. In some examples, the model is stored at the user device 104 of FIG. 1 and/or in a cloud-based environment accessible to the user device 104. The model may then be executed by the anomaly detection circuitry 102. In some examples, the model can be executed by an example central processing unit (CPU) of a user device (e.g., the user device 104 of FIG. 1).

Once trained, the deployed model may be operated in an inference phase to process data. In the inference phase, data to be analyzed (e.g., live data) is input to the model, and the model executes to create an output. This inference phase can be thought of as the AI “thinking” to generate the output based on what it learned from the training (e.g., by executing the model to apply the learned patterns and/or associations to the live data). In some examples, input data undergoes pre-processing before being used as an input to the machine learning model. Moreover, in some examples, the output data may undergo post-processing after it is generated by the AI model to transform the output into a useful result (e.g., a display of data, an instruction to be executed by a machine, etc.).

In some examples, output of the deployed model may be captured and provided as feedback. By analyzing the feedback, an accuracy of the deployed model can be determined. If the feedback indicates that the accuracy of the deployed model is less than a threshold or other criterion, training of an updated model can be triggered using the feedback and an updated training data set, hyperparameters, etc., to generate an updated, deployed model.

FIG. 2 is a block diagram of an example implementation of the example anomaly detection circuitry 102 of FIG. 1. The anomaly detection circuitry 102 of FIG. 2 may be instantiated (e.g., creating an instance of, bring into being for any length of time, materialize, implement, etc.) by programmable circuitry such as a Central Processor Unit (CPU) executing first instructions. Additionally or alternatively, the anomaly detection circuitry 102 of FIG. 2 may be instantiated (e.g., creating an instance of, bring into being for any length of time, materialize, implement, etc.) by (i) an Application Specific Integrated Circuit (ASIC) and/or (ii) a Field Programmable Gate Array (FPGA) structured and/or configured in response to execution of second instructions to perform operations corresponding to the first instructions. It should be understood that some or all of the circuitry of FIG. 2 may, thus, be instantiated at the same or different times. Some or all of the circuitry of FIG. 2 may be instantiated, for example, in one or more threads executing concurrently on hardware and/or in series on hardware. Moreover, in some examples, some or all of the circuitry of FIG. 2 may be implemented by microprocessor circuitry executing instructions and/or FPGA circuitry performing operations to implement one or more virtual machines and/or containers. Additionally, in some examples some or all of the circuitry of FIG. 2 is effectively highly specialized and/or otherwise specific computing resources by virtue of programmable instructions and/or unique structural configuration(s) (e.g., FPGA structures).

In the illustrated example of FIG. 2, the anomaly detection circuitry 102 includes example data interface circuitry 202, example data processing circuitry 204, example feature identification circuitry 206, example hyperparameter selection circuitry 208, example model training circuitry 210, example model execution circuitry 212, example report generation circuitry 214, and an example database 216.

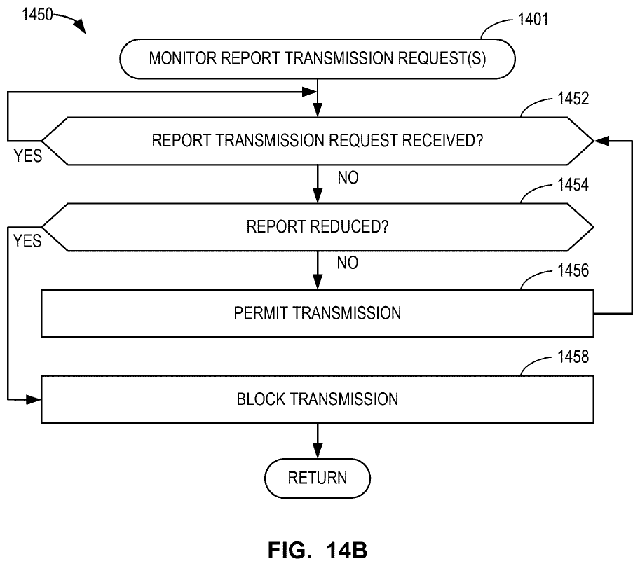

The data interface circuitry 202 of FIG. 2 can access, receive, and/or otherwise obtain data to be utilized by the anomaly detection circuitry 102. For example, the data interface circuitry 202 can obtain the price series data 106 and/or the historical data 110 of FIG. 1. In some examples, the data interface circuitry 202 obtains the price series data 106 and/or the historical data 110 via the network 108 of FIG. 1. Additionally or alternatively, the price series data 106 and/or the historical data 110 can be preloaded in the anomaly detection circuitry 102 and/or input by a user (e.g. via the user device 104 of FIG. 1). In some examples, the data interface circuitry 202 provides the price series data 106 and/or the historical data 110 to the database 216 for storage therein. In some examples, the data interface circuitry 202 is instantiated by programmable circuitry executing data interface circuitry instructions and/or configured to perform operations such as those represented by the flowchart(s) of FIGS. 14A, 14B, and/or 15.

The example database 216 of FIG. 2 stores data utilized and/or obtained by the anomaly detection circuitry 102. The example database 216 of FIG. 2 is implemented by any memory, storage device and/or storage disc for storing data such as, for example, flash memory, magnetic media, optical media, solid state memory, hard drive(s), thumb drive(s), etc. Furthermore, the data stored in the example database 216 may be in any data format such as, for example, binary data, comma delimited data, tab delimited data, structured query language (SQL) structures, etc. While, in the illustrated example, the example database 216 is illustrated as a single device, the example database 216 and/or any other data storage devices described herein may be implemented by any number and/or type(s) of memories.

The example data processing circuitry 204 of FIG. 2 processes (e.g., pre-processes) data to be utilized by the anomaly detection circuitry 102 for training and/or execution of the anomaly detection model(s). For example, the data processing circuitry 204 can process the historical data 110 to remove duplicate data samples from the historical data 110. In some examples, the data processing circuitry 204 can generate (e.g., create, calculate) one or more example features of the historical data 110. For example, the historical data 110 can include first features (e.g., retailer price, reference price, retailer description, reference description) for respective ones of the historical data samples represented in the historical data 110, and the data processing circuitry 204 can calculate one or more second features (e.g., calculated features, determined features) based on the first features. In some examples, the data processing circuitry 204 can determine, for respective one(s) of the historical data samples, at least one of a factored price (e.g., a product of the retailer price and a correction factor), a price index feature corresponding to a first difference (e.g., a first percentage difference) between the factored price and the retailer price (e.g., based on example Equation 1 above), a previous price index feature corresponding to a second difference (e.g., a second percentage difference) between the retailer price and the reference price (e.g., based on example Equation 2 above), a percentage difference feature corresponding to a third difference (e.g., a third percentage difference) between the factored price and the reference price relative to an average of the factored price and the reference price (e.g., based on example Equation 3 above), or a previous percentage difference feature corresponding to a fourth difference (e.g., a fourth percentage difference) between the retailer price and the reference price relative to an average of the retailer price and the reference price (e.g., based on example Equation 4 above).

Further, in some examples, the data processing circuitry 204 can determine an example ratio between the factored price and the reference price for a respective historical data sample, an example common word count feature corresponding to a number of common words between the retailer description and the reference description for a respective historical data, and/or normalized Levenshtein distance between the retailer description and the reference description. In some examples, the data processing circuitry 204 determines one or more example binary values based on the first features and/or the second features. For example, the data processing circuitry 204 can determine, for respective one(s) of the historical data samples, a first binary value (e.g., an applied factor feature) representative of whether a correction factor has been applied to the retailer price, a second binary value (e.g., a suggested factor feature) representative of whether a correction factor has been suggested, a third binary value representative of whether the third difference between the factored price and the reference price is greater than the fourth difference between the retailer price and the reference price, a fourth binary value representative of whether at least one of the retailer description or the reference description includes a numerical value, and/or a fifth binary value representative of whether at least one of the retailer description or the reference description includes the correction factor. In some examples, the data processing circuitry 204 determines dummy variables for respective different retailers in a corresponding geographic region.

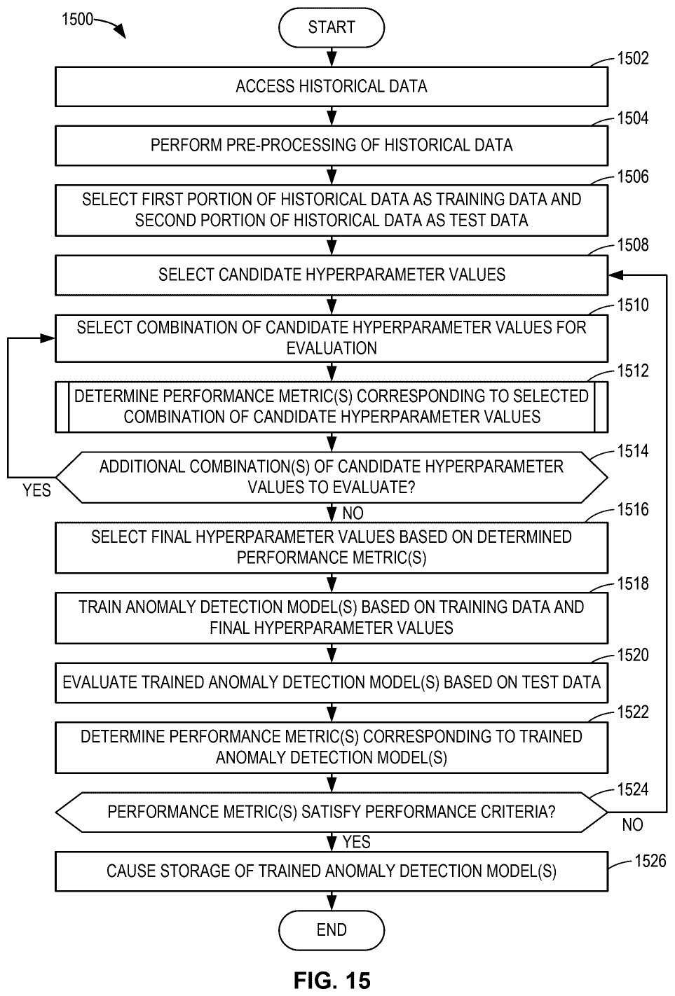

In some examples, the data processing circuitry 204 determines, based on the historical data 110, one or more additional features in addition to or instead of one(s) of the features discussed above. In some examples, the data processing circuitry 204 provides the feature(s) to the database 216 for storage therein. In some examples, the data processing circuitry 204 is instantiated by programmable circuitry executing data processing circuitry instructions and/or configured to perform operations such as those represented by the flowchart(s) of FIG. 15.

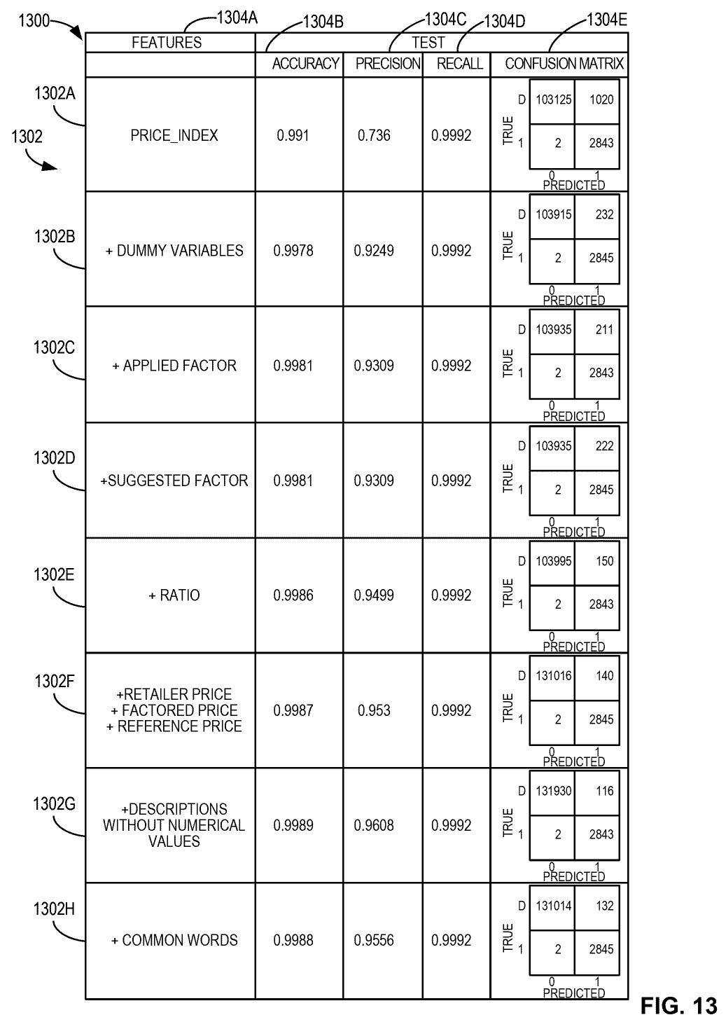

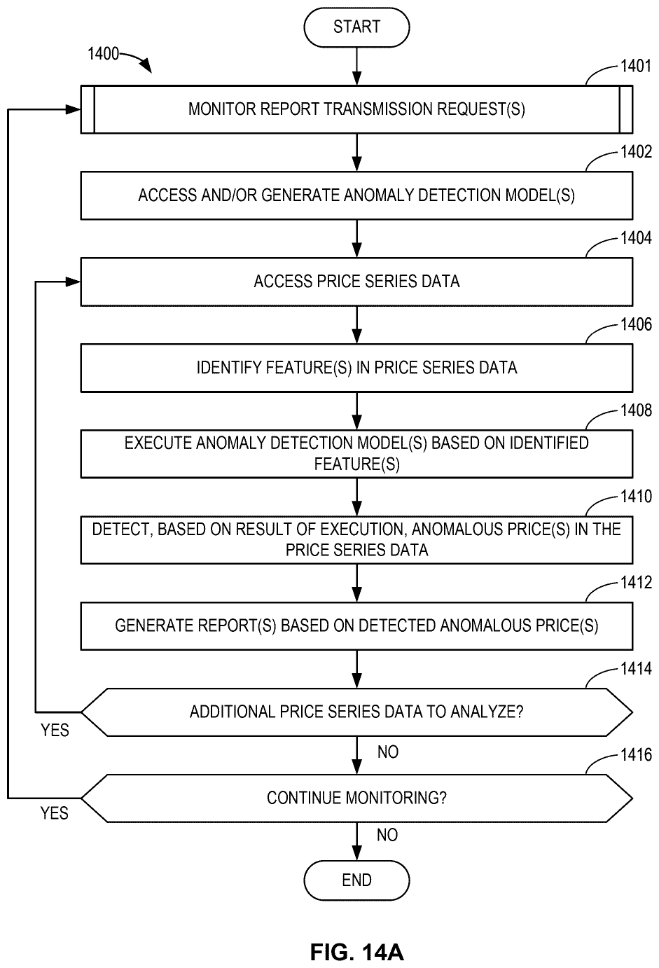

The example feature identification circuitry 206 of FIG. 2 selects and/or identifies one or more of the features determined and/or obtained by the data processing circuitry 204. For example, the feature identification circuitry 206 can select an example subset of the features for use in generating and/or training the anomaly detection model(s). In some examples, the feature identification circuitry 206 selects the subset of the features based on user input to the user device 104 of FIG. 1 and/or to the anomaly detection circuitry 102. For example, the subset of the features may be predefined and/or pre-selected (e.g., by a user). In some examples, the feature identification circuitry 206 can select the subset based on an example forward approach (e.g., a forward feature selection process). For example, the feature identification circuitry 206 can iteratively add one(s) of the features to the anomaly detection model(s), and evaluates performance of the anomaly detection model(s) using the selected features. An example forward approach that may be utilized by the feature identification circuitry 206 is described further below in connection with FIG. 13. In some examples, based on results of the forward approach, the feature identification circuitry 206 selects the subset of features including the first differences between the factored prices and the retailer prices (e.g., the “PRICE_INDEX” features), the dummy variables (e.g., the “XCODEGR DUMMIES” features), the first binary values (e.g., the “APPLIED FACTOR” features), the second binary values (e.g., the “SUGGESTED_FACTOR” features), the fourth binary values (e.g., the “DESCRIPTIONS_WITHOUT_NUMBERS” features), the ratios between the factored and reference prices, the retailer prices (e.g., the “RETAILER PRICE” features), the reference prices (e.g., the “REFERENCE_PRICE” features), and the factored prices (e.g., the “FACTORED_PRICE” features).

In some examples, the feature identification circuitry 206 can select a different subset of the features (e.g., including one or more different features in addition to or instead of one(s) of the features included in the subset above). In some examples, the feature identification circuitry 206 provides the selected subset of features to the database 216 for storage therein. In some examples, the feature identification circuitry 206 is instantiated by programmable circuitry executing feature identification circuitry instructions and/or configured to perform operations such as those represented by the flowchart(s) of FIG. 14A.

The example hyperparameter selection circuitry 208 of FIG. 2 selects one or more example hyperparameters and/or associated values (e.g., hyperparameter values) for the anomaly detection model(s). In some examples, the hyperparameters include a threshold depth (e.g., a maximum depth) associated with a binary decision tree of the anomaly detection model(s), a first threshold number of samples to split an internal node of the binary decision tree (e.g., minimum number of samples to split an internal node), and/or a second threshold number of samples corresponding to a leaf node of the binary decision tree (e.g., a minimum number of samples to be a leaf node). Further, the hyperparameters can include first and second weights associated with respective classes (e.g., anomalous and non-anomalous) to be predicted and/or output based on the binary decision tree.

In some examples, values for the respective hyperparameters are selected and/or adjusted to achieve a balance between generalization and memorization in the underlying anomaly detection model(s). For example, when a relatively low value is selected for the threshold depth, the anomaly detection model(s) may be unable to effectively learn patterns in the historical data 110. In contrast, when a relatively high value is selected for the threshold depth, the anomaly detection model(s) may be overly specific to the patterns in the historical data 110 and, as a result, may not generalize well to other data. Further, in some examples, a first weight associated with the anomalous class can be greater than the second weight associated with the non-anomalous class to compensate for the relatively small number of anomalous data samples relative to non-anomalous data samples in the price series data 106.

In some examples, the hyperparameter selection circuitry 208 selects and/or determines, for respective ones of the hyperparameters, a set of candidate hyperparameter values from which the hyperparameter values can be selected. For example, the set(s) of candidate hyperparameter values can be selected based on user input (e.g., to the user device 104 of FIG. 1), based on commonly and/or previously used hyperparameter values, etc. In one example, the hyperparameter selection circuitry 208 determines a first example set of first candidate hyperparameter values for the threshold depth (e.g., [2, 4, 6, 8, 10]), a second example set of second candidate hyperparameter values for the first threshold number of samples to split an internal node (e.g., [2, 5, 10]), and a third example set of third candidate hyperparameter values for the second threshold number of samples for a leaf node (e.g., [4, 6, 8]). Additionally, the hyperparameter selection circuitry 208 can determine a fourth example set of fourth candidate hyperparameter values for the first class weight (e.g., [240, 260, 280, 300]) associated with a first class (e.g., an anomalous class) of data samples, and/or a fifth example set of fifth candidate hyperparameter values for the second class weight (e.g., 1) associated with a second class (e.g., a non-anomalous class) of the data samples. In some examples, the first class weight associated with the anomalous class is greater than the second class weight associated with the non-anomalous class. In some examples, one or more different sets of the candidate hyperparameter values may be used instead.

In some examples, the hyperparameter selection circuitry 208 determines an example grid of the candidate hyperparameter values by determining possible combinations between the candidate hyperparameter values. For example, the grid includes some (e.g., all) of the possible combinations between the first, second, third, fourth, and/or fifth candidate hyperparameter values. In some examples, the hyperparameter selection circuitry 208 provides the grid of candidate hyperparameter values to the model training circuitry 210 for use in training the anomaly detection model(s). Additionally or alternatively, the hyperparameter selection circuitry 208 can provide the grid of candidate hyperparameter values to the database 216 for storage therein. In some examples, the hyperparameter selection circuitry 208 is instantiated by programmable circuitry executing hyperparameter selection circuitry instructions and/or configured to perform operations such as those represented by the flowchart(s) of FIG. 15.

The example model training circuitry 210 trains the anomaly detection model(s) based on the historical data 110 and/or based on the grid of candidate hyperparameter values. In examples disclosed herein, a binary decision tree (e.g., a binary decision classifier) is used for the anomaly detection model(s). In some examples, the binary decision tree enables classification of data samples into one of the first class (e.g., the anomalous class) or the second class (e.g., the non-anomalous class) based on identified features of the data samples. In examples disclosed herein, the data to be classified (e.g., the historical data 110 and/or the price series data 106 of FIG. 1) is unbalanced data, in which a significant majority (e.g., 90%, 95%, etc.) of data samples correspond to the second class (e.g., the non-anomalous class), and relatively few (e.g., 10%, 5%, etc.) of the data samples correspond to the first class (e.g., the anomalous class). By utilizing a binary decision tree for the anomaly detection model(s), weights (e.g., class weights) can be assigned to the respective classes to compensate for the unbalanced data. For example, a first class weight can be assigned to the first class, and a second class weight (e.g., less than the first weight) can be assigned to the second class. While a binary decision tree is used in this example, one or more different models (e.g., a random forest model, a gradient boosting model, a support vector machine model, a XGBoost model, a linear regression model, a lasso regression model, a ridge regression model, a K-nearest neighbors model, etc.) may be used instead.

Turning to FIG. 3, a first example process flow 300 to generate and/or train example anomaly detection model(s) is shown. For example, because the first process flow 300 is not capable of performance by a human or in the human mind, the first process flow 300 may be performed by the model training circuitry 210 of FIG. 2. In the illustrated example of FIG. 3, the model training circuitry 210 selects, from the historical data 110, an example training dataset 302 and an example testing dataset (e.g., a validation dataset) 304. For example, the model training circuitry 210 divides the historical data 110 into a first portion and a second portion, where the training dataset corresponds to the first portion and the testing dataset corresponds to a second portion of the historical data 110 (e.g., less than the first portion). In some examples, the training dataset corresponds to 80% of the historical data 110, and the testing dataset corresponds to 20% of the historical data 110. In some examples, the first portion and/or the second portion may be different. In some examples, the training dataset and the testing dataset include previously-reviewed reports (e.g., price exception reports that were previously reviewed by one or more humans) that include data samples and corresponding labels (e.g., ground truth labels) indicating whether the respective data samples are anomalous or non-anomalous.

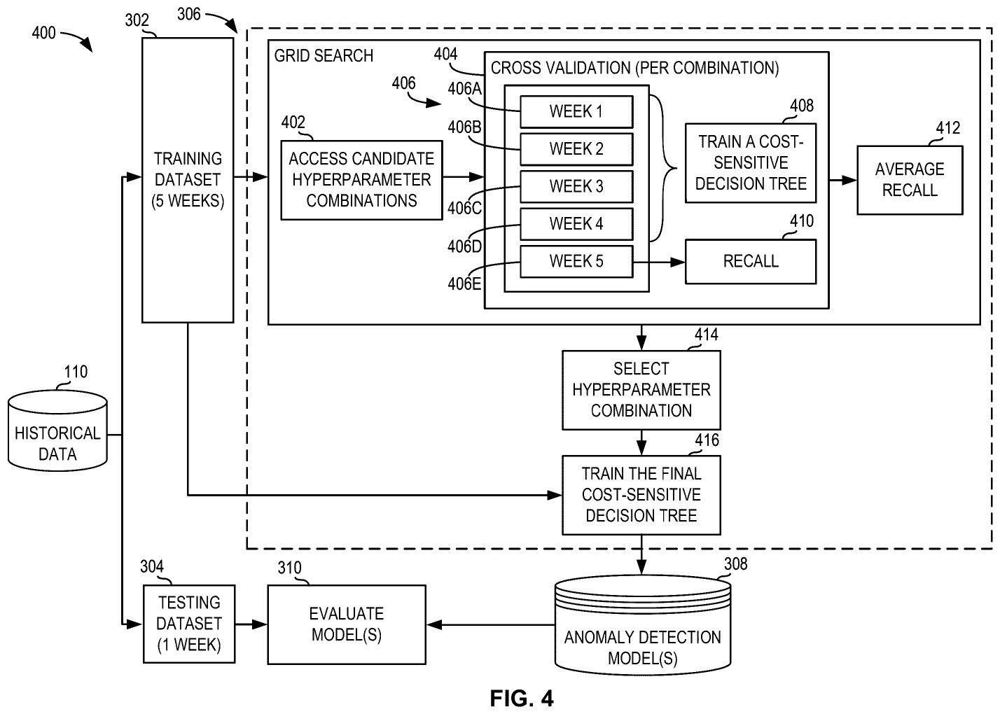

In the illustrated example of FIG. 3, the model training circuitry 210 executes and/or performs an example model training process 306 based on the training dataset 302. For example, the model training circuitry 210 trains an example decision tree to detect and/or classify anomalies (e.g., anomalous data samples) in the training dataset 302. The model training process 306 of FIG. 3 is described further below in connection with FIG. 4. In some examples, as a result of executing the model training process 306, the model training circuitry 210 outputs one or more example anomaly detection models 308 that may be utilized by the anomaly detection circuitry 102 of FIGS. 1 and/or 2 to detect anomalies in the price series data 106 of FIG. 1.

In some examples, the model training circuitry 210 performs an example model testing process (e.g., a model evaluation process) 310 to test and/or evaluate the trained anomaly detection model(s) 308 based on the testing dataset 304. For example, the model training circuitry 210 executes the trained anomaly detection model(s) 308 based on features represented in the testing dataset 304 to output predicted labels corresponding to respective ones of the data samples in the testing dataset 304. For example, the predicted labels indicate whether the respective ones of the data samples are predicted to be anomalous or non-anomalous. In some examples, the model training circuitry 210 evaluates performance of the anomaly detection model(s) 308 based on a comparison of the predicted labels with corresponding ground truth labels of the respective data samples. For example, the model training circuitry 210 obtains the ground truth labels from the testing dataset 304, and compares the predicted labels to the corresponding ground truth labels (e.g., to determine whether ones of the predicted labels match the corresponding ground truth labels). In some examples, the model training circuitry 210 determines whether respective ones of the predicted labels correspond to a true positive, a true negative, a false positive, or a false negative. In some examples, a true positive refers to when both the predicted label and the ground truth label indicate that the corresponding data sample is anomalous (e.g., the anomaly detection model(s) correctly predict that the data sample is anomalous). In some examples, a true negative refers to when both the predicted label and the ground truth label indicate that the corresponding data sample is non-anomalous (e.g., the anomaly detection model(s) correctly predict that the data sample is non-anomalous). In some examples, a false positive refers to when the predicted label indicates that the corresponding data sample is anomalous, but the ground truth label indicates that the corresponding data sample is non-anomalous (e.g., the anomaly detection model(s) incorrectly predict that the non-anomalous data sample is anomalous). In some examples, a false negative refers to when the predicted label indicates that the corresponding data sample is non-anomalous, but the ground truth label indicates that the corresponding data sample is anomalous (e.g., the anomaly detection model(s) incorrectly predict that the anomalous data sample is non-anomalous).

In some examples, based on the comparison between the predicted and ground truth labels, the model training circuitry 210 determines example counts associated with respective ones of the predictions. For example, the model training circuitry 210 determines a first count of the true positives, a second count of the true negatives, a third count of the false positives, and a fourth count of the false negatives. Further, based on the counts, the model training circuitry 210 can determine one or more example performance metrics associated with the anomaly detection model(s) 308. For example, the model training circuitry 210 can determine an example accuracy metric, an example recall metric, and/or an example precision metric based on the counts. In some examples, the model training circuitry 210 determines the accuracy metric by dividing the number of correct predictions (e.g., the true positives and the true negatives, a sum of the first and second counts, etc.) by a total number of the predictions (e.g., both correct and incorrect predictions, a sum of the first, second, third, and fourth counts, etc.) output by the anomaly detection model(s) 308. In some examples, the model training circuitry 210 determines the recall metric by dividing the number of true positives (e.g., the number of data samples correctly predicted to be anomalous, the first count, etc.) by a sum of the true positives and false negatives (e.g., the number of data samples that are anomalous, a sum of the first and fourth counts, etc.). In some examples, the model training circuitry 210 determines the precision metric by dividing the number of true positives (e.g., the number of data samples correctly predicted to be anomalous, the first count, etc.) by a sum of the true positives and false positives (e.g., the number of data samples predicted to be anomalous, a sum of the first and third counts, etc.).

In some examples, the model training circuitry 210 determines whether the performance metric(s) satisfy example performance criteria associated with the anomaly detection model(s) 308. For example, the model training circuitry 210 can determine that the performance criteria are satisfied when the recall metric satisfies (e.g., is greater than or equal to) an example recall threshold (e.g., 90%, 92%, 95%, 98%, etc.). In some examples, the model training circuitry 210 determines that the performance criteria are satisfied when the accuracy metric satisfies (e.g., is greater than or equal to) an example accuracy threshold (e.g., 90%, 92%, 95%, 98%, etc.). Additionally or alternatively, the model training circuitry 210 can determine that the performance criteria are satisfied when the precision metric satisfies (e.g., is greater than or equal to) an example recall threshold (e.g., 90%, 92%, 95%, 98%, etc.). In some examples, the threshold(s) (e.g., the recall threshold, the accuracy threshold, and/or the precision threshold) are selected based on user input and/or are preloaded in the model training circuitry 210. In some examples, one or more different performance criteria and/or thresholds (e.g., in addition to or instead of the recall threshold, the accuracy threshold, and/or the precision threshold) may be used to evaluate the anomaly detection model(s) 308. In some examples, the model training circuitry 210 determines that the performance criteria are satisfied when at least one of the thresholds (e.g., the recall threshold) is satisfied. For example, the recall threshold may be selected for evaluation of the anomaly detection model(s) 308 to reduce (e.g., minimize) the number of false negatives (e.g., the anomalous data samples incorrectly predicted to be non-anomalous) output by the anomaly detection model(s) 308.

In some examples, in response to the model training circuitry 210 determining that the performance criteria are not satisfied, the model training circuitry 210 triggers further training and/or re-training of the anomaly detection model(s) 308. In some examples, the model training circuitry 210 trains and/or re-trains the anomaly detection model(s) 308 until the performance criteria are satisfied and/or until a training duration (e.g., a duration for which the model training circuitry 210 trains the anomaly detection model(s) 308) satisfies (e.g., is greater than or equal to) a threshold duration. Alternatively, in response to the model training circuitry 210 determining that the performance criteria are satisfied, the model training circuitry 210 provides the trained anomaly detection model(s) 308 to the database 216 of FIG. 2 for storage and/or for execution by the model execution circuitry 212 of FIG. 2.

FIG. 4 is a second example process flow 400 to perform the model training process 306 of FIG. 3. For example, because the second process flow 400 is not capable of performance by a human or in the human mind, the second process flow 400 may be performed by the model training circuitry 210 of FIG. 2. In the illustrated example of FIG. 4, the model training circuitry 210 selects the training dataset 302 and the testing dataset 304 from the historical data 110. In this example, the historical data 110 includes data samples collected across and/or representative of a six-week period, and the model training circuitry 210 selects five weeks of the data samples for the training dataset 302 and one week of the data samples for the testing dataset 304. In some examples, the time period(s) represented by the data samples in the historical data 110, the training dataset 302, and/or the testing dataset 304 may be different.

In the illustrated example of FIG. 4, the model training circuitry 210 defines and/or accesses the grid of candidate hyperparameter combinations (block 402) determined by the hyperparameter selection circuitry 208 of FIG. 2. Further, the model training circuitry 210 performs a cross-validation process (block 404) for respective ones of the combinations. For example, the model training circuitry 210 divides the training dataset 302 into example folds (e.g., portions, groups) 406, where a first fold 406A includes first data samples corresponding to a first week (e.g., week 1) represented in the training dataset 302, a second fold 406B includes second data samples corresponding to a second week (e.g., week 2) represented in the training dataset 302, a third fold 406C includes third data samples corresponding to a third week (e.g., week 3) represented in the training dataset 302, a fourth fold 406C includes fourth data samples corresponding to a fourth week (e.g., week 4) represented in the training dataset 302, and a fifth fold 406 includes fifth data samples corresponding to a fifth week (e.g., week 5) represented in the training dataset 302.

In the example of FIG. 4, the model training circuitry 210 selects a first one of the candidate hyperparameter combinations, and performs the cross-validation process 404 for the selected combination. To perform the cross-validation process 404, the model training circuitry 210 iteratively selects one of the folds 406 as a validation fold, and selects remaining ones of the folds 406 as training folds. In the example of FIG. 4, for a first iteration of the cross-validation process 404 for the selected hyperparameter combination, the model training circuitry 210 selects the fifth fold 406E as the validation fold, and selects the first, second, third, and fourth folds 406A, 406B, 406C, 406D as the training folds. In such examples, the model training circuitry 210 trains an example binary decision tree (e.g., a cost-sensitive decision tree, a candidate anomaly detection model) (block 408) based on the training folds and the selected hyperparameter combination. For example, the model training circuitry 210 identifies and/or selects features (e.g., training features) from the data samples included in the training folds (e.g., the folds 406A-406D). In some examples, the model training circuitry 210 selects, for the training features, the subset of features identified by the features identification circuitry 206 of FIG. 2. For example, the model training circuitry 210 can select and/or determine, from the training folds, the first differences between the factored prices and the retailer prices, the dummy variables, the first binary values representative of whether a correction factor has been applied, the second binary values representative of whether a correction factor has been suggested, the fourth binary values representative of whether the descriptions include numerical values, the ratios between the factored and reference prices, the retailer prices, the reference prices, and the factored prices. In some examples, one or more different features can additionally or alternatively be used as the training features.

In the example of FIG. 4, the model training circuitry 210 generates and/or trains a binary decision tree based on the selected hyperparameter combination and the training folds. Further, the model training circuitry 210 correlates the training features of respective data samples with ground truth labels of the respective data samples. In some examples, the model training circuitry 210 adjusts and/or selects parameter(s) (e.g., weights) associated with the binary decision tree(s) based on the correlations (e.g., between the training features and the ground truth labels) such that, when executed based on the training features, the binary decision tree(s) output the ground truth labels for the respective data samples. In some examples, the model training circuitry 210 tests and/or evaluates the trained binary decision tree(s) based on the validation fold (e.g., the fifth fold 406E). For example, the model training circuitry 210 selects validation features (e.g., corresponding to the subset of features described above) from the data samples in the validation fold, and executes the trained binary decision tree(s) based on the validation features (e.g., by providing the validation features as input to the binary decision tree(s)).

As a result of execution of the trained binary decision tree(s), the model training circuitry 210 outputs and/or determines predicted labels for respective data samples in the validation fold. In some examples, the model training circuitry 210 determines, based on a comparison between the predicted labels and the corresponding ground truth labels from the validation fold, an example recall metric corresponding to the trained binary decision tree(s) (block 410). For example, the model training circuitry 210 determines the recall metric by determining a first number of data samples the trained binary decision tree(s) correctly predicted to be anomalous (e.g., the number of true positives), and dividing the first number by a second number of data samples labelled as anomalous based on the ground truth labels (e.g., the sum of the true positives and false negatives). While the recall metric is used in this example, an accuracy metric and/or a precision metric may additionally or alternatively be used.

In some examples, the model training circuitry 210 stores (e.g., in the database 216 of FIG. 2) the recall metric in association with the selected hyperparameter combination. Further, the model training circuitry 210 repeats the training of a binary decision tree (block 408) using different ones of the folds 406 as the validation fold. For example, in FIG. 4, the model training circuitry 210 iteratively trains and evaluates five binary decision trees for the selected hyperparameter combination, where respective ones of the folds 406 are used as the validation fold for the five binary decision trees (e.g., the first fold 406A is used as the validation fold for a first binary decision tree, the second fold 406B is used as the validation fold for a second binary decision tree, the third fold 406C is used as the validation fold for a third binary decision tree, the fourth fold 406D is used as the validation fold for a fourth binary decision tree, and the fifth fold 406E is used as the validation fold for a fifth binary decision tree), and remaining ones of the folds 406 are used as the training folds for the respective binary decision trees. In some examples, as a result of the evaluation of the five binary decision trees, the model training circuitry 210 determines five recall metrics corresponding to the respective decision trees. Further, the model training circuitry 210 determines, based on an average of the five recall metrics, an average recall metric corresponding to the selected hyperparameter combination (block 412). While the average recall metric is used in this example, a different metric (e.g., a minimum, a maximum, a median, etc.) associated with the five recall metrics may be used instead.

In some examples, the model training circuitry 210 stores (e.g., in the database 216 of FIG. 2), the average recall metric in association with the selected hyperparameter combination. Further, the model training circuitry 210 iteratively performs the cross-validation process 404 of FIG. 4 for remaining ones of the candidate hyperparameter combinations. As a result, the model training circuitry 210 determines and/or stores average recall metrics for respective ones of the candidate hyperparameter combinations. In some examples, the model training circuitry 210 selects one of the candidate hyperparameter combinations based on the average recall metrics (block 414). For example, the model training circuitry 210 can select the one of the candidate hyperparameter combinations corresponding to a greatest average recall metric (e.g., relative to remaining ones of the average recall metrics) as a final hyperparameter combination to be used in the anomaly detection model(s) 308.

In the example of FIG. 4, the model training circuitry 210 generates and/or trains a final binary decision tree based on the final hyperparameter combination and the training dataset 302 (block 416). For example, the model training circuitry 210 correlates the subset of features in the training dataset 302 with ground truth labels of the respective data samples in the training dataset 302. In some examples, the model training circuitry 210 adjusts and/or selects parameter(s) associated with the final binary decision tree based on the correlations such that, when executed, the final binary decision tree outputs predicted labels for the respective data samples. In some examples, the model training circuitry 210 generates the anomaly detection model(s) 308 based on the final trained binary decision tree, and provides the anomaly detection model(s) 308 to the database 216 of FIG. 2 for storage and/or for execution by the model execution circuitry 212 of FIG. 2. In some examples, the model training circuitry 210 can execute the model testing process 310 (e.g., described above in connection with FIG. 3) to test and/or evaluate the trained anomaly detection model(s) 308 based on the testing dataset 304. In some examples, the model training circuitry 210 is instantiated by programmable circuitry executing model training circuitry instructions and/or configured to perform operations such as those represented by the flowchart(s) of FIGS. 15 and/or 16.

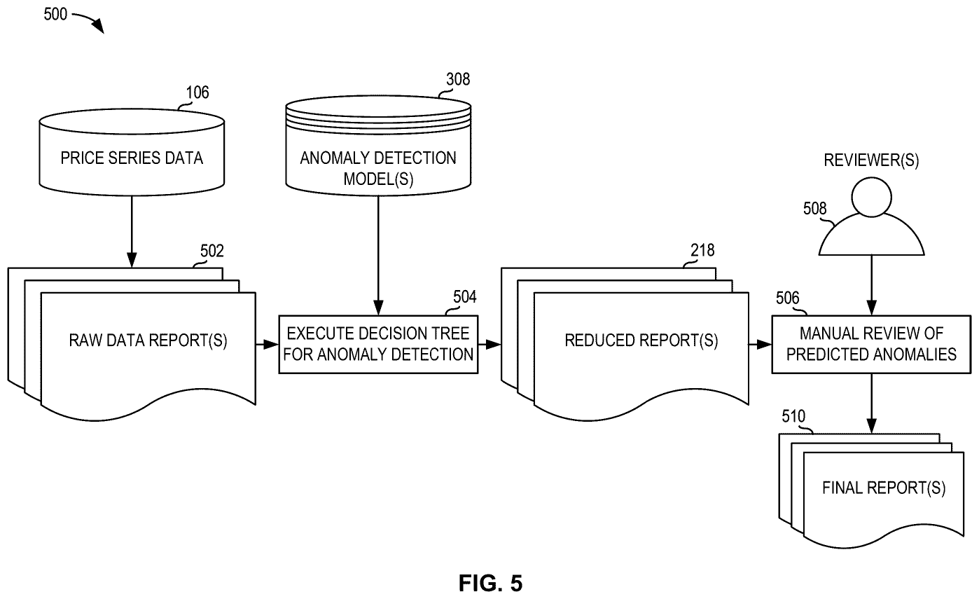

Returning to FIG. 2, the model execution circuitry 212 can utilize and/or execute the trained anomaly detection model(s) 308 of FIGS. 3 and/or 4 to detect anomalies in the price series data 106. Further, based on the detected anomalies, the report generation circuitry 214 of FIG. 2 can generate and/or output one or more example reports (e.g., reduced report(s), reduced price exception report(s)) 218. Detection of the anomalies and/or generation of the reduced report(s) 218 is described further below in connection with FIG. 5.

FIG. 5 illustrates a third example process flow 500 that may be executed and/or performed by the anomaly detection circuitry 102 of FIGS. 1 and/or 2 to detect anomalies in the price series data 106. In the illustrated example of FIG. 5, the model execution circuitry 212 of FIG. 2 accesses (e.g., from the database 216 of FIG. 2), the anomaly detection model(s) 308 and the price series data 106. In some examples, the price series data 106 includes one or more example data samples and associated features represented in a tabular format (e.g., the table 112 of FIG. 1). For example, the price series data 106 can include one or more example raw data reports (e.g., new report(s), unanalyzed report(s)) 502 representative of a first quantity of data samples collected for a corresponding time period, geographic region, retailer, etc. In some examples, the raw data report(s) 502 can include at least one of the retailer prices, the reference prices, the retailer descriptions, or the reference descriptions determined and/or obtained for the respective data samples. In some examples, the raw data report(s) 502 can include one or more additional features determined and/or calculated for the respective data samples (e.g., factored price features, price index features, ratios, etc.).

In this example, based on the price series data 106 (e.g., represented in the raw data report(s) 502), the model execution circuitry 212 executes one or more trained binary decision trees corresponding to the anomaly detection model(s) 308 (block 504). For example, the model execution circuitry 212 provides a subset of features from the price series data 106 (e.g., the subset of features identified by the feature identification circuitry 206 of FIG. 2) as input to the binary decision tree(s), and determines predicted labels for respective data samples of the price series data 106 based on an output of the binary decision tree(s). In some examples, the predicted labels indicate whether respective ones of the data samples are predicted to be anomalous or non-anomalous. In some examples, the model execution circuitry 212 causes storage of the predicted labels in the database 216 of FIG. 2 in association with the corresponding data samples. In some examples, the model execution circuitry 212 is instantiated by programmable circuitry executing model execution circuitry instructions and/or configured to perform operations such as those represented by the flowchart(s) of FIGS. 14A and/or 15.

In the illustrated example of FIG. 5, the report generation circuitry 214 of FIG. 2 generates and/or outputs the report(s) 218 based on the predicted labels. For example, the report generation circuitry 214 can generate a first one of the reports 218 including first data samples from the price series data 106 that are predicted to be anomalous. In such examples, the report generation circuitry 214 identifies the first data samples (e.g., anomalous data samples) based on anomalous predicted labels, and/or identifies second data samples (e.g., non-anomalous data samples) based on non-anomalous predicted labels.

In some examples, the report generation circuitry 214 generates the first one of the reduced reports 218 to include the anomalous data samples and omit (e.g., not include) the non-anomalous data samples. As a result, the first one of the reduced reports 218 includes a second quantity of data samples (e.g., corresponding to the anomalous data samples), where the second quantity of data samples is less than the first quantity of data samples in the price series data 106 and/or the associated raw data report(s) 502. Additionally or alternatively, the report generation circuitry 214 can generate a second one of the reduced reports 218 to include the non-anomalous data samples and omit (e.g., not include) the anomalous data samples. As a result, the second one of the reduced reports 218 includes a third quantity of data samples (e.g., corresponding to the non-anomalous data samples), where the third quantity is greater than the second quantity of data samples (e.g., in the first one of the reduced report(s) 218) and less than the first quantity of data samples (e.g., in the price series data 106). Stated differently, a difference between the first quantity and the second quantity corresponds to the third quantity of the non-anomalous data samples.

In some examples, the report generation circuitry 214 provides the reduced report(s) 218 to the database 216 of FIG. 2 for storage therein. In some examples, the report generation circuitry 214 sends and/or transmits (e.g., via the network 108 of FIG. 1) the reduced report(s) 218 to one or more devices communicatively coupled to the anomaly detection circuitry 102. In some examples, the second quantity of data samples (e.g., the quantity of the anomalous data samples) included in the first one of the reduced reports 218 is significantly less than (e.g., less than 5% of, less than 2% of, less than 1% of, etc.) the first quantity of data samples in the price series data 106. As a result, the first one of the reduced reports 218 utilizes substantially less memory and/or less bandwidth for storage and/or transmission (e.g., compared to the price series data 106).

In some examples, the report generation circuitry 214 can output the reduced report(s) 218 for presentation (e.g., by the user device 104 of FIG. 1 and/or one or more other devices). For example, the report generation circuitry 214 can cause presentation (e.g., display) of the first one of the reduced reports 218 on the user device 104 to enable manual audit and/or review of the predicted anomalies (block 506). In this example, the reduced report(s) 218 output for presentation can be reviewed by one or more reviewers (e.g., humans) 508 to differentiate between correct predictions (e.g., anomalous data samples predicted to be and/or classified as anomalous) and incorrect predictions (e.g., non-anomalous data samples predicted to be and/or classified as anomalous) in the reduced report(s) 218. In some examples, the reviewer(s) 508 can adjust (e.g., via user input to the user device 104) one(s) of the labels for corresponding one(s) of the data samples, and/or can indicate (e.g., via the user input) action(s) to be performed for corresponding one(s) of the data samples. In some examples, based on the adjustments and/or input from the reviewer(s) 508, the report generation circuitry 214 generates one or more example final reports (e.g., final price exception reports) 510. For example, the report generation circuitry 214 generates the final report(s) 510 by removing, from the reduced report(s) 218, one(s) of the data samples which were incorrectly predicted as anomalous. In some examples, the report generation circuitry 214 provides the final report(s) 510 to the database 216 of FIG. 2 for storage therein. In some examples, the report generation circuitry 214 is instantiated by programmable circuitry executing report generation circuitry instructions and/or configured to perform operations such as those represented by the flowchart(s) of FIGS. 14A and/or 14B.

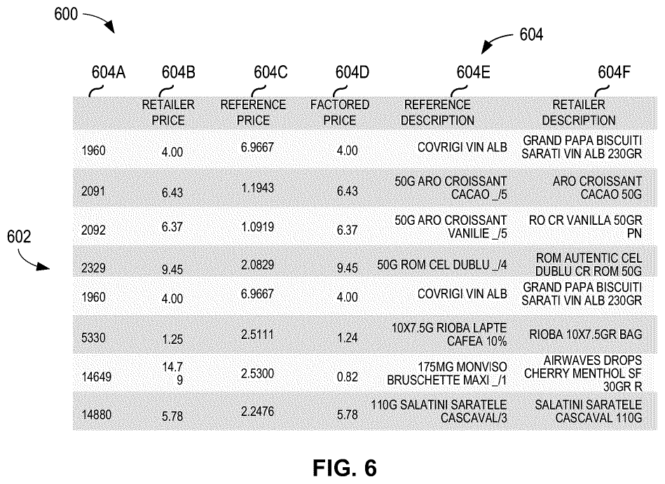

FIG. 6 illustrates a first example reduced report 600 that may be generated by the anomaly detection circuitry 102 of FIGS. 1 and/or 2. In the illustrated example of FIG. 6, the first reduced report 600 can correspond to a first one of the reduced report(s) 218 (or a portion thereof) generated by the report generation circuitry 214 of FIG. 2. In this example, the first reduced report 600 includes example rows 602 corresponding to respective data samples (e.g., from the price series data 106 of FIG. 1) classified as anomalous by the anomaly detection circuitry 102 of FIGS. 1 and/or 2. Stated differently, the first reduced report 600 of FIG. 6 omits (e.g., does not include) data samples classified as non-anomalous by the anomaly detection circuitry 102. Further, the first reduced report 600 includes example columns 604 corresponding to respective example features of the respective data samples. In the example of FIG. 6, a first example column 604A includes identifiers corresponding to respective ones of the data samples, a second example column 604B includes retailer prices corresponding to the respective ones of the data samples, a third example column 604C includes reference prices corresponding to the respective ones of the data samples, a fourth example column 604D includes factored prices corresponding to the respective ones of the data samples, a fifth example column 604E includes reference descriptions corresponding to the respective ones of the data samples, and a sixth example column 604F includes retailer descriptions corresponding to the respective ones of the data samples. While six of the columns 604 are included in the first reduced report 600 of FIG. 6, one or more of the columns 604 may be omitted, and/or one or more different columns (e.g., corresponding to respective different feature(s) of the data samples) may be included.

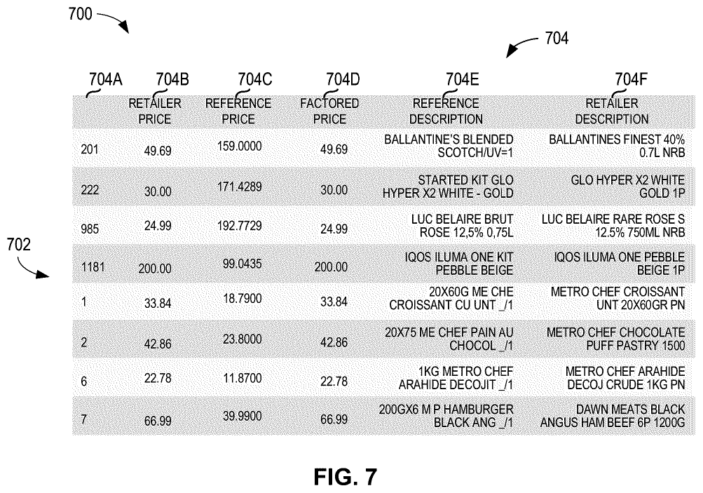

FIG. 7 illustrates a second example reduced report 700 that may be generated by the anomaly detection circuitry 102 of FIGS. 1 and/or 2. In the illustrated example of FIG. 7, the second reduced report 700 can correspond to a second one of the reduced report(s) 218 (or a portion thereof) that may be generated by the report generation circuitry 214 of FIG. 2 (e.g., in addition to or instead of the first reduced report 600 of FIG. 6). In this example, the second reduced report 700 includes example rows 702 corresponding to respective data samples (e.g., from the price series data 106 of FIG. 1) classified as non-anomalous by the anomaly detection circuitry 102 of FIGS. 1 and/or 2. Stated differently, the second reduced report 700 of FIG. 7 omits (e.g., does not include) data samples classified as anomalous by the anomaly detection circuitry 102. Further, the second reduced report 700 includes example columns 704 corresponding to respective example features of the respective data samples.

In the illustrated example of FIG. 7, the columns 704 of the second reduced report 700 (e.g., a first example column 704A, a second example column 704B, a third example column 704C, a fourth example column 704D, a fifth example column 704E, and a sixth example column 704F) correspond to the columns 604 of the first reduced report 600 of FIG. 6. In some examples, one or more of the columns 704 of FIG. 7 may be omitted, and/or one or more different columns (e.g., corresponding to respective different feature(s) of the data samples) may be included in the second reduced report 700.

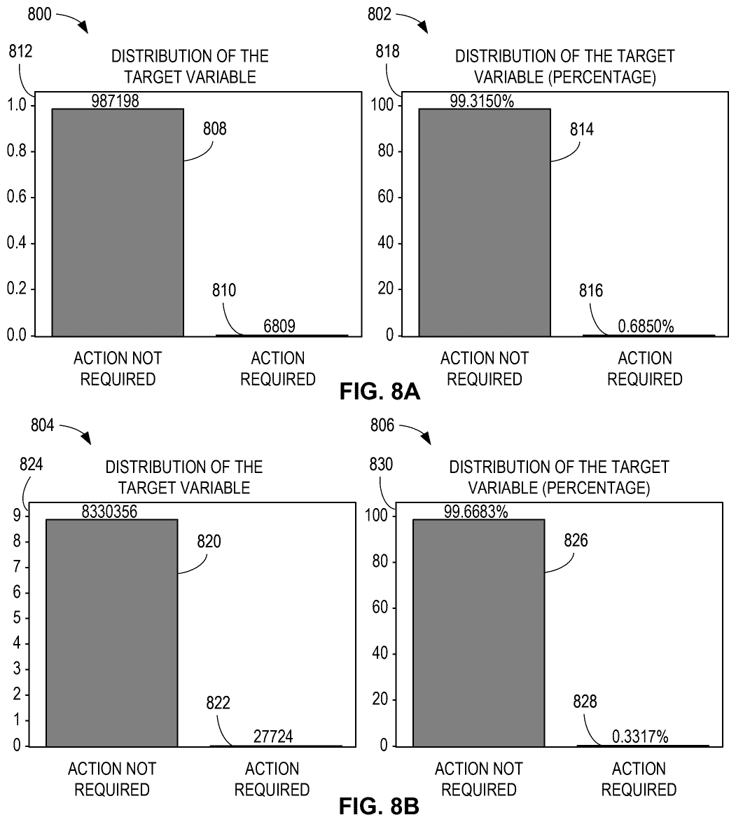

FIG. 8A illustrates first and second example graphs 800, 802 representative of example distributions of first data samples corresponding to a first example geographic region (e.g., Romania), and FIG. 8B illustrates third and fourth example graphs 804, 806 representative of example distributions of second data samples corresponding to a second example geographic region (e.g., Russia). In some examples, one(s) of the graphs 800, 802, 804, 806 may be generated based on results from manual review of the first and second data samples. As shown in the illustrated examples of FIGS. 8A and/or 8B, the data samples to be evaluated (e.g., using the anomaly detection model(s) 308) are unbalanced (e.g., a relatively small quantity (e.g., 2% or less, 1% or less, etc.) of the data samples are anomalous).

In the illustrated example of FIG. 8A, the price series data 106 of FIG. 1 includes a first total quantity (e.g., 994,007) of the first data samples corresponding to the first geographic region. In this example, the first graph 800 includes a first bar 808 representative of the first quantity of the first data samples included in the first portion (e.g., 987,198) and a second bar 810 representative of the second quantity of the first data samples included in the second portion (e.g., 6,809), where a first example axis (e.g., a first vertical axis) 812 of the first graph 800 represents the quantity (e.g., in millions). Further, the second graph 802 includes a third bar 814 representative of the first proportion of the first data samples included in the first portion (e.g., 99.3150%) and a fourth bar 816 representative of the second proportion of the first data samples included in the second portion (e.g., 0.6850%), where a second example axis (e.g., a second vertical axis) 818 of the second graph 802 represents the proportion (e.g., in percentages). In some examples, value(s) corresponding to the first quantity, the second quantity, the first proportion, and/or the second proportion may be different.

Turning to FIG. 8B, the price series data 106 of FIG. 1 includes a second total quantity (e.g., 8,358,080) of the second data samples corresponding to the second geographic region. In the example of FIG. 8B, the third graph 804 includes a fifth bar 820 representative of the first quantity of the second data samples included in the first portion (e.g., 8,330,356) and a sixth bar 822 representative of the second quantity of the second data samples included in the second portion (e.g., 27,724), where a third example axis (e.g., a third vertical axis) 824 of the third graph 804 represents the quantity (e.g., in millions). Further, the fourth graph 806 includes a seventh bar 826 representative of the first proportion of the second data samples included in the first portion (e.g., 99.6683%) and an eighth bar 828 representative of the second proportion of the second data samples included in the second portion (e.g., 0.3317%), where a fourth example axis (e.g., a fourth vertical axis) 830 of the fourth graph 806 represents the proportion (e.g., in percentage). In some examples, value(s) corresponding to the first quantity, the second quantity, the first proportion, and/or the second proportion may be different.

In some examples, different ones of the anomaly detection model(s) 308 may be utilized and/or trained for respective different geographic regions (e.g., the first geographic region and the second geographic region). In some examples, as a result of execution of the anomaly detection model(s) 308 for the respective geographic region(s), less than 1% of the corresponding data samples are identified as anomalous (e.g., requiring action and/or further review).

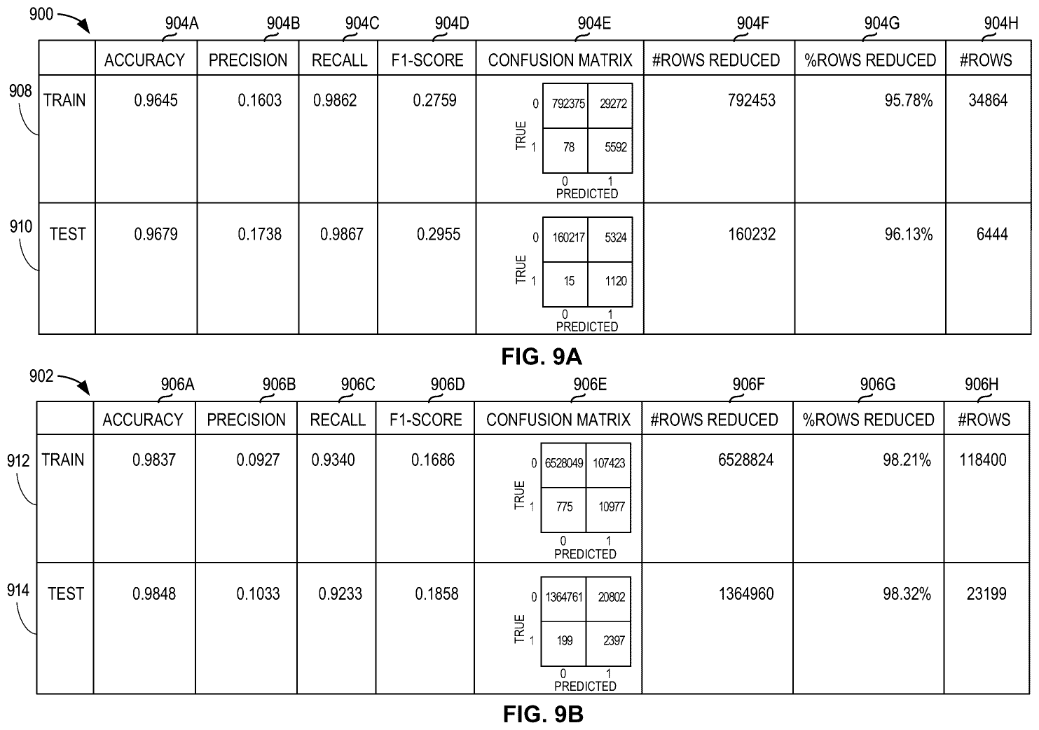

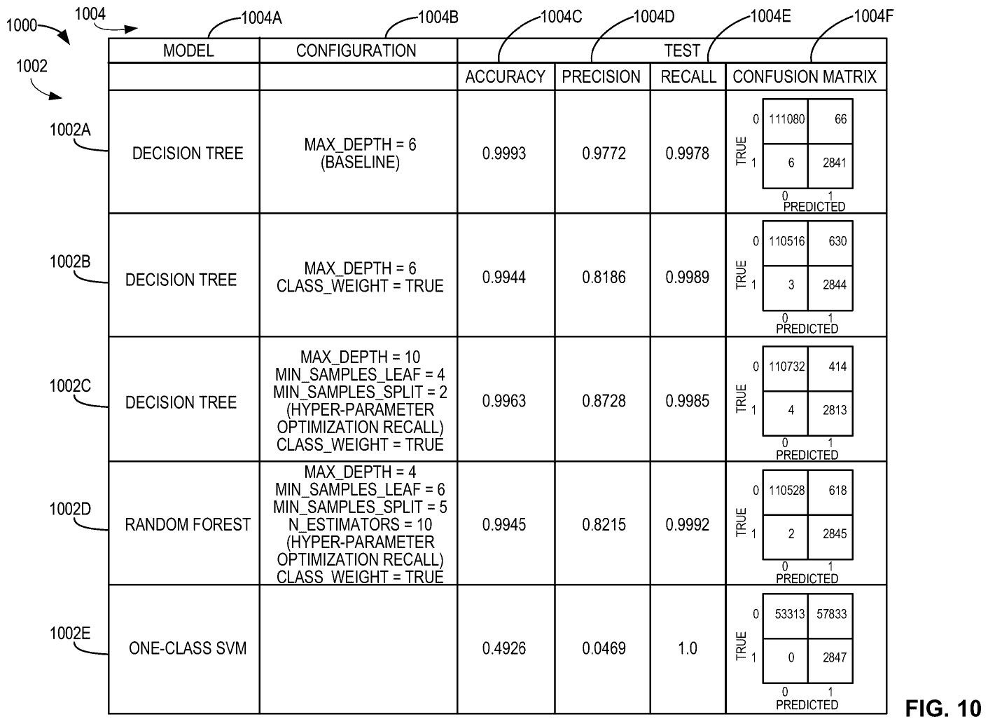

FIG. 9A illustrates a first example table 900 representative of first example performance metrics corresponding to the first geographic region (e.g., Romania), and FIG. 9B illustrates a second example table 902 representative of second example performance metrics corresponding to the second geographic region (e.g., Russia). In some examples, the anomaly detection circuitry 102 of FIGS. 1 and/or 2 determines the first performance metrics based on execution of first one(s) of the anomaly detection model(s) 308 using a first portion of the historical data 110 (e.g., corresponding to the first geographic region). Similarly, the anomaly detection circuitry 102 determines the second performance metrics based on execution of second one(s) of the anomaly detection model(s) 308 using a second portion of the historical data 110 (e.g., corresponding to the second geographic region).

In the illustrated examples of FIGS. 9A and/or 9B, the anomaly detection circuitry 102 divides the first portion of the historical data 110 (e.g., corresponding to the first geographic region) into a first training dataset (e.g., the training dataset 302 of FIG. 3) and a first testing dataset (e.g., the testing dataset 304 of FIG. 3), where the first one of the anomaly detection model(s) 308 is trained based on the first training dataset and validated based on the first testing dataset. Similarly, the anomaly detection circuitry 102 divides the second portion of the historical data 110 (e.g., corresponding to the second geographic region) into a second training dataset and a second testing dataset, where the second one of the anomaly detection model(s) 308 is trained based on the second training dataset and validated based on the second testing dataset.

In the illustrated example of FIG. 9A, the first table 900 includes a first row 908 including first example training performance metrics (e.g., resulting from execution of the first one of the anomaly detection model(s) 308 based on the first training dataset), and a second row 910 including first example testing performance metrics (e.g., resulting from execution of the first one of the anomaly detection model(s) 308 based on the first testing dataset). Further, in the illustrated example of FIG. 9B, the second table 902 includes a third row 912 including second example training performance metrics (e.g., resulting from execution of the second one of the anomaly detection model(s) 308 based on the second training dataset), and a fourth row 914 including second performance metrics resulting from execution of the second one of the anomaly detection model(s) 308 based on the second testing dataset). In the examples of FIGS. 9A and/or 9B, the first and second tables 900, 902 include examples columns 904, 906 corresponding to respective different performance metrics. For example, the first and second tables 900, 902 include first example columns 904A, 906A corresponding to an accuracy metric, second example columns 904B, 906B corresponding to a precision metric, third example columns 904C, 906C corresponding to a recall metric, fourth example columns 904D, 906D corresponding to an F-1 score metric, fifth example columns 904E, 906E corresponding to a confusion matrix metric, sixth example columns 904F, 906F corresponding to a row count reduction metric, seventh example columns 904G, 906G corresponding to a row percentage reduction metric, and eighth example columns 904H, 906H corresponding to a row count metric. In some examples, one or more different performance metrics may be included in the first table 900 and/or the second table 902.

In some examples, the anomaly detection circuitry 102 of FIGS. 1 and/or 2 determines the performance metrics of FIGS. 9A and/or 9B based on respective quantities of true positives, true negatives, false positives, and false negatives predicted and/or output based on execution of the anomaly detection model(s) 308. In some examples, the F-1 score metric is based on a product of the precision metric and the recall metric relative to (e.g., divided by) a sum of the precision metric and the recall metric, multiplied by two. In some examples, the confusion matrix metric corresponds to a 2-by-2 matrix representative of respective quantities of the true positives, the true negatives, the false positives, and the false negatives determined based on the respective anomaly detection model(s) 308 and the respective dataset (e.g., the first training dataset, the second training dataset, the first testing dataset, or the second testing dataset). For example, a first quadrant (e.g., a top-left quadrant) of the matrix represents a first quantity of the true negatives, a second quadrant (e.g., a top-right quadrant) of the matrix represents a second quantity of the false positives, a third quadrant (e.g., a bottom-left quadrant) of the matrix represents a third quantity of the false negatives, and a fourth quadrant (e.g., a bottom-right quadrant) of the matrix represents a fourth quantity of the true positives. Further, the row count reduction metric is based on a sum of the true negatives and the false negatives, and the row percentage reduction metric is based on the row count reduction metric (e.g., the sum of the true negative and false negatives) relative to the total number of predictions (e.g., the sum of true positives, true negatives, false positives, and false negatives). In some examples, the row count metric corresponds to a sum of the true positives and the false positives.

While example values for respective ones of the performance metrics are shown in FIGS. 9A and/or 9B, one or more of the values may be different in some examples. In some examples, as shown in the seventh columns 904G, 906G of FIGS. 9A and/or 9B, execution of the anomaly detection model(s) 308 may result in at least a 95% reduction in the number of rows to be manually reviewed.

FIG. 10 illustrates an example table 1000 comparing example performance metrics obtained using respective different machine learning models. For example, a first row 1002A corresponds to a first example binary decision tree model with first example hyperparameters, a second example row 1002B corresponds to a second example binary decision tree model with second example hyperparameters, a third row 1002C corresponds to a third example binary decision tree model with third example hyperparameters, a fourth row 1002D corresponds to an example random forest model, and a fifth row 1002E corresponds to an example one-class support vector machine (SVM) model.

In the illustrated example of FIG. 10, the table 1000 includes a first column 1004A including example model type(s) (e.g., decision tree, random forest, one-class SVM, etc.) corresponding to the respective rows 1002. Further, the table 1000 includes a second column 1004B including example configurations corresponding to the respective rows 1002. For example, the second column 1004B includes example parameters (e.g., hyperparameters) used for the model(s) represented in the respective rows 1002. In the illustrated example of FIG. 10, the table 1000 includes third, fourth, fifth, and sixth example columns 1004C, 1004D, 1004E, 1004F including example performance metrics determined as a result of executing the model(s) corresponding to the respective rows 1002. For example, the anomaly detection circuitry 102 trains the model(s) based on a training dataset (e.g., the training dataset 302 of FIG. 3) and the respective hyperparameters in the second column 1004B. Further, the anomaly detection circuitry 102 executes the trained model(s) based on a testing dataset (e.g., the testing dataset 304 of FIG. 3) to determine the performance metrics of the third, fourth, fifth, and sixth columns 1004C, 1004D, 1004E, 1004F. In this example, the third column 1004C includes example accuracy metrics, the fourth column 1004D includes example precision metrics, the fifth column 1004E includes example recall metrics, and the sixth column 1004F includes example confusion matrices determined by the anomaly detection circuitry 102 for the respective rows 1002.

In the illustrated example of FIG. 10, the first binary decision tree (e.g., corresponding to the first row 1002A) has a threshold (e.g., maximum) depth of 6, and execution of the first binary decision tree results in an accuracy metric of 0.9993, a precision metric of 0.9772, a recall metric of 0.9978, and a confusion matrix including 111,080 true negatives, 66 false positives, 6 false negatives, and 2,841 true positives. In this example, the second binary decision tree (e.g., corresponding to the second row 1002B) has a threshold (e.g., maximum) depth of 6 and includes weights for respective classes (e.g., anomalous and non-anomalous), and execution of the second binary decision tree results in an accuracy metric of 0.9944, a precision metric of 0.8186, a recall metric of 0.9989, and a confusion matrix including 110,516 true negatives, 630 false positives, 3 false negatives, and 2,844 true positives. In this example, for the third binary decision tree (e.g., corresponding to the third row 1002C), a threshold (e.g., maximum) depth is 10, a threshold (e.g., minimum) number of samples corresponding to a leaf node is 4, a threshold (e.g., minimum) number of samples to split in internal node is 2, and the classes are weighted. In some examples, execution of the third binary decision tree results in an accuracy metric of 0.9963, a precision metric of 0.8728, a recall metric of 0.9985, and a confusion matrix including 110,732 true negatives, 414 false positives, 4 false negatives, and 2,813 true positives. In this example, for the random forest model (e.g., corresponding to the fourth row 1002D), a threshold (e.g., maximum) depth is 4, a threshold (e.g., minimum) number of samples corresponding to a leaf node is 6, a threshold (e.g., minimum) number of samples to split in internal node is 5, a number of estimators is 10, and the classes are weighted. In some examples, execution of the random forest model results in an accuracy metric of 0.9945, a precision metric of 0.8215, a recall metric of 0.9992, and a confusion matrix including 110,528 true negatives, 618 false positives, 2 false negatives, and 2,845 true positives. In some examples, execution of the one-class SVM model (e.g., corresponding to the fifth row 1002E) results in an accuracy metric of 0.4926, a precision metric of 0.0469, a recall metric of 1.0, and a confusion matrix including 53,313 true negatives, 57,833 false positives, 0 false negatives, and 2,847 true positives.

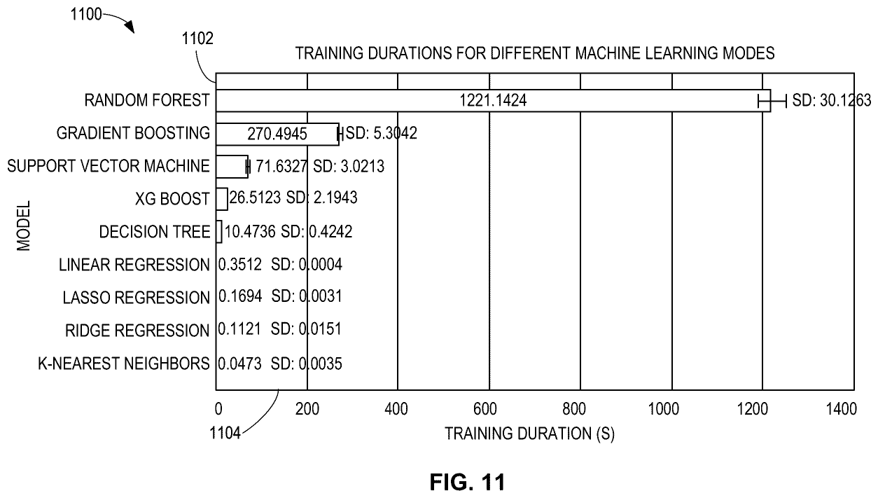

FIG. 11 illustrates a first example graph 1100 representative of example training durations corresponding to respective different models (e.g., machine learning models). For example, the training durations represent durations for which the respective models are trained based on a training dataset (e.g., the training dataset 302 of FIG. 3). In the illustrated example of FIG. 11, a first example axis (e.g., a vertical axis) 1102 represents the respective different models (e.g., a random forest model, a gradient boosting model, a support vector machine (SVM) model, an XG boost model, a decision tree model, a linear regression model, a lasso regression model, a ridge regression model, and a K-nearest neighbors model), and a second example axis (e.g., a horizontal axis) 1104 represents the training durations (e.g., in seconds).

In the illustrated example of FIG. 11, the random forest model corresponds to a longest average training duration (e.g., relative to remaining one(s) of the models) of 1221.1424 seconds with a standard deviation of 30.1263 seconds, followed by the gradient boosting model (e.g., 270.4945 seconds with a standard deviation of 5.3042 seconds), the SVM model (e.g., 71.6327 seconds with a standard deviation of 3.0213 seconds), the XG boost model (e.g., 26.5123 seconds with a standard deviation of 2.1943 seconds), the decision tree model (e.g., 10.4736 seconds with a standard deviation of 0.4242 seconds), the linear regression model (e.g., 0.3512 seconds with a standard deviation of 0.0004 seconds), the lasso regression model (e.g., 0.1694 seconds with a standard deviation of 0.0031 seconds), the ridge regression model (e.g., 0.1121 seconds with a standard deviation of 0.0151 seconds), and the K-nearest neighbors model (e.g., 0.0473 seconds with a standard deviation of 0.0035 seconds).

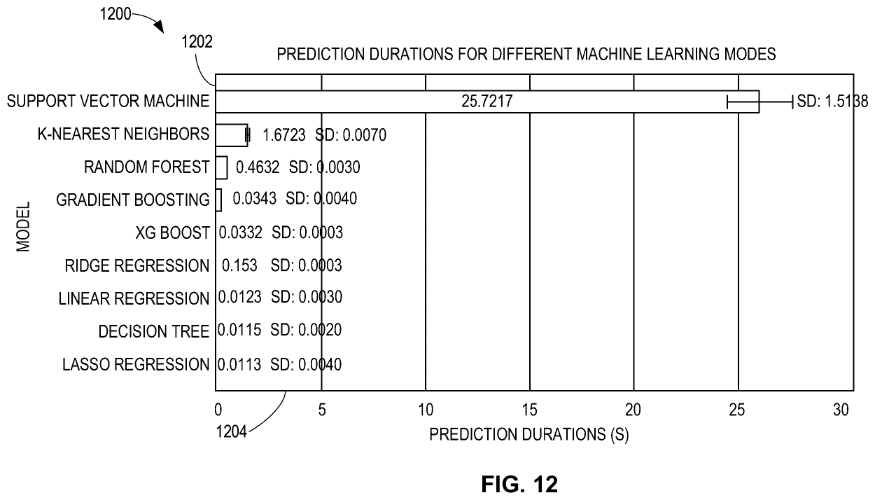

FIG. 12 illustrates a second example graph 1200 representative of example prediction durations (e.g., execution durations) corresponding to the respective different models discussed in connection with FIG. 11. For example, the prediction durations represent durations for which the respective models are executed, based on a dataset (e.g., the price series data 106 of FIG. 1), to output predicted labels (e.g., anomalous and non-anomalous) for respective samples in the dataset. In the illustrated example of FIG. 12, a first example axis (e.g., a vertical axis) 1202 represents the respective different models (e.g., the random forest model, the gradient boosting model, the SVM model, the XG boost model, the decision tree model, the linear regression model, the lasso regression model, the ridge regression model, and the K-nearest neighbors model), and a second example axis (e.g., a horizontal axis) 1204 represents the prediction durations (e.g., in seconds).

In the illustrated example of FIG. 12, the SVM model corresponds to a longest average prediction duration (e.g., relative to remaining one(s) of the models) of 25.7217 seconds with a standard deviation of 1.5138 seconds, followed by the K-nearest neighbors model (e.g., 1.6723 seconds with a standard deviation of 0.0070 seconds), the random forest model (e.g., 0.4632 seconds with a standard deviation of 0.0030 seconds), the gradient boosting model (e.g., 0.0343 seconds with a standard deviation of 0.0040 seconds), the XG boost model (e.g., 0.0332 seconds with a standard deviation of 0.0003 seconds), the ridge regression model (e.g., 0.0153 seconds with a standard deviation of 0.0004 seconds), the linear regression model (e.g., 0.0123 seconds with a standard deviation of 0.0030 seconds), the decision tree model (e.g., 0.0115 seconds with a standard deviation of 0.0020 seconds), and the lasso regression model (e.g., 0.0113 seconds with a standard deviation of 0.0040 seconds). In some examples, one or more different models (e.g., in addition to or instead of one(s) of the models represented in FIGS. 11 and/or 12) may be represented in the first graph 1100 of FIG. 11 and/or in the second graph 1200 of FIG. 12.

FIG. 13 illustrates an example table 1300 representative of an example forward approach for feature selection for the anomaly detection model(s) 308 of FIG. 2. While a forward approach is used in FIG. 13 for the selection of features, one or more different feature selection techniques (e.g., a backward approach, etc.) may additionally or alternatively be used. In the illustrated example of FIG. 13, using the forward approach, the anomaly detection circuitry 102 of FIGS. 1 and/or 2 generates the anomaly detection model(s) 308 by adding, at respective iterations, one or more features to the subset of features to be used as input to the anomaly detection model(s) 308. For example, a first candidate subset (e.g., used in a first iteration) can include a first example feature, a second candidate subset (e.g., used in a second iteration subsequent to the first iteration) can include the first feature and a second example feature, etc. In some examples, the anomaly detection circuitry 102 evaluates performance metric(s) of the anomaly detection model(s) 308 at the respective iterations to determine the subset of features that satisfies example criteria associated with the performance metric(s). For example, the anomaly detection circuitry 102 determines first performance metric(s) associated with the first candidate subset of features used in the first iteration, and determines second performance metric(s) associated with the second candidate subset of features used in the second iteration.

In some examples, when the second performance metric(s) are not improved compared to the first performance metric(s) (e.g., one or more of the second performance metric(s) are less than a corresponding one or more of the first performance metric(s)), the anomaly detection circuitry 102 determines that addition of the second feature does not improve performance of the anomaly detection model(s) 308 and, thus, selects the first candidate subset as a final subset of features for use in the anomaly detection model(s) 308. Alternatively, when the second performance metric(s) are improved compared to the first performance metric(s) (e.g., one or more of the second performance metric(s) are greater than a corresponding one or more of the first performance metric(s)), the anomaly detection circuitry 102 determines that addition of one or more features (e.g., one or more candidate subsets of features) is to be evaluated. In some examples, when the second performance metric(s) satisfy example performance criteria (e.g., the second performance metric(s) satisfy one or more performance thresholds), the anomaly detection circuitry 102 selects the second candidate subset as the final subset of features for use in the anomaly detection model(s) 308.

In the illustrated example of FIG. 13, the table 1300 includes example rows 1302 corresponding to respective features added to a candidate subset of features. For example, a first row 1302A corresponds to a price index feature, a second row 1302B corresponds to a dummy variable feature, a third row 1302C corresponds to an applied factor feature (e.g., binary value(s) representative of whether a correction factor has been applied), a fourth row 1302D corresponds to a suggested factor feature (e.g., binary value(s) representative of whether a correction factor has been suggested), a fifth row 1302E corresponds to a ratio (e.g., between a factored price and a reference price), a sixth row 1302F corresponds to a retailer price feature, a factored price feature, and a reference price feature, a seventh row 1302G corresponds to a description without numbers feature (e.g., binary value(s) representative of whether a description includes numerical values), and an eighth row 1302H corresponds to a common word count feature (e.g., a quantity of common words between the retailer and reference descriptions).

In the example of FIG. 13, the table 1300 includes a first column 1304A representing the features corresponding to the respective rows 1302. Further, the table 1300 includes second, third, fourth column 1304B, 1304C, 1304D, 1304E representing respective example performance metrics corresponding to the respective rows 1302. For example, the second column 1304B includes example accuracy metrics, the third column 1304C includes example precision metrics, the fourth column 1304D includes example recall metrics, and the fifth column 1304E includes example confusion matrices corresponding to the respective rows 1302. In this example, the performance of the anomaly detection model(s) 308 improves (e.g., the performance metric(s) in the second, third, and/or fourth columns 1304B, 1304C, 1304D increase and/or stay the same) when features corresponding to the first through sixth columns 1302A-1302G are added to the candidate subset of features. However, in this example, when the feature corresponding to the seventh column 1304H (e.g., the common word count feature) is added to the candidate subset of features, the performance metrics (e.g., the accuracy metric and/or the precision metric) decrease. As a result, the anomaly detection circuitry 102 selects the features corresponding to the first through sixth columns 1302A-1302G as the final subset of features to be used for the anomaly detection model(s) 308.

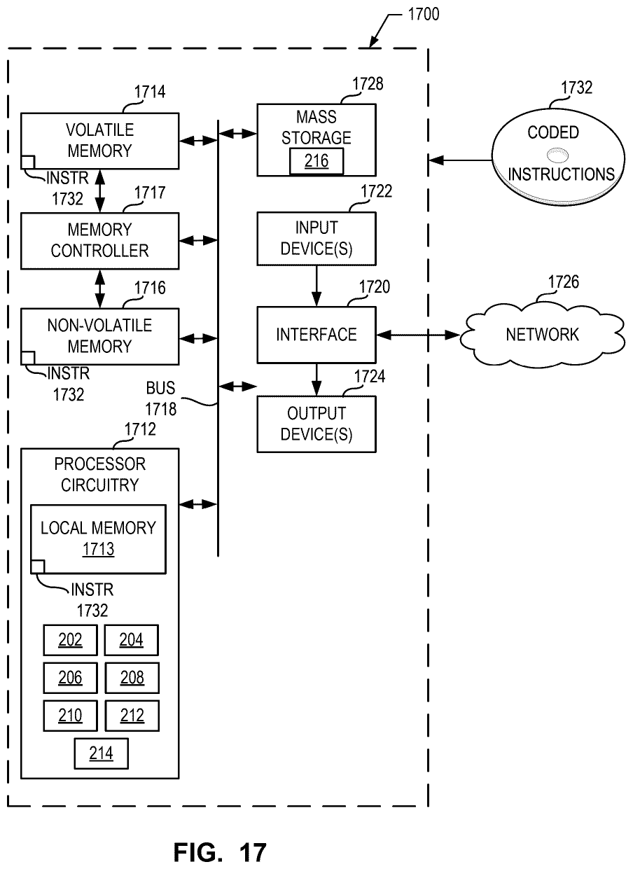

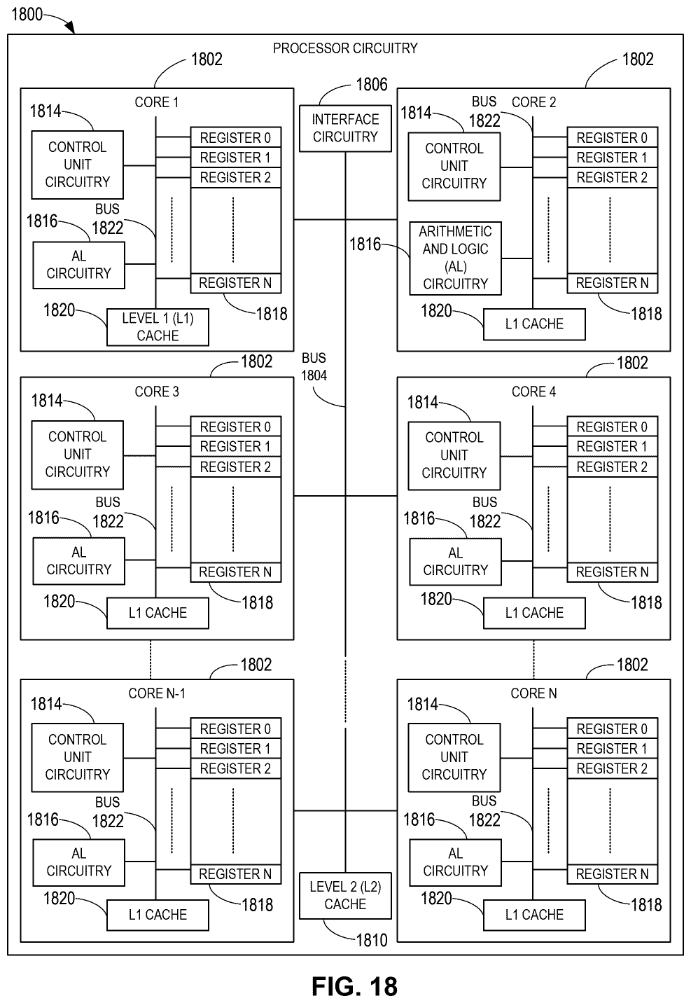

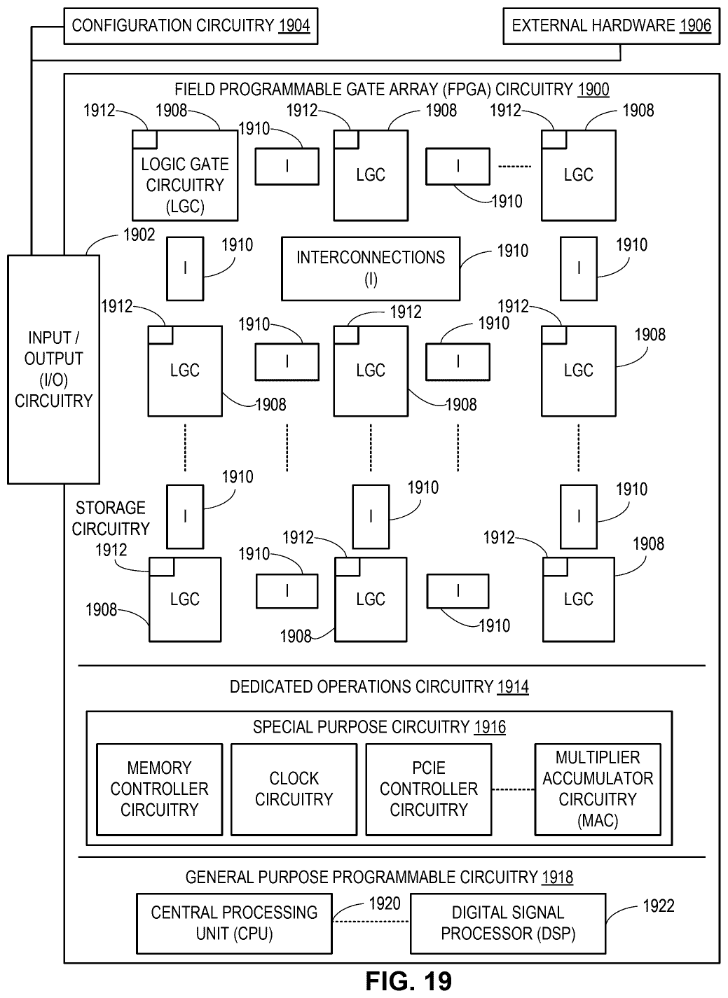

In some examples, the anomaly detection circuitry 102 includes means for obtaining data. For example, the means for obtaining data may be implemented by the data interface circuitry 202. In some examples, the data interface circuitry 202 may be instantiated by programmable circuitry such as the example programmable circuitry 1712 of FIG. 17. For instance, the data interface circuitry 202 may be instantiated by the example microprocessor 1800 of FIG. 18 executing machine executable instructions such as those implemented by at least blocks 1401, 1402, 1404, 1414 of FIG. 14A, block 1452 of FIG. 14B, and/or block 1502 of FIG. 15. In some examples, the data interface circuitry 202 may be instantiated by hardware logic circuitry, which may be implemented by an ASIC, XPU, or the FPGA circuitry 1900 of FIG. 19 configured and/or structured to perform operations corresponding to the machine readable instructions. Additionally or alternatively, the data interface circuitry 202 may be instantiated by any other combination of hardware, software, and/or firmware. For example, the data interface circuitry 202 may be implemented by at least one or more hardware circuits (e.g., processor circuitry, discrete and/or integrated analog and/or digital circuitry, an FPGA, an ASIC, an XPU, a comparator, an operational-amplifier (op-amp), a logic circuit, etc.) configured and/or structured to execute some or all of the machine readable instructions and/or to perform some or all of the operations corresponding to the machine readable instructions without executing software or firmware, but other structures are likewise appropriate.

In some examples, the anomaly detection circuitry 102 includes means for processing data. For example, the means for processing data may be implemented by the data processing circuitry 204. In some examples, the data processing circuitry 204 may be instantiated by programmable circuitry such as the example programmable circuitry 1712 of FIG. 17. For instance, the data processing circuitry 204 may be instantiated by the example microprocessor 1800 of FIG. 18 executing machine executable instructions such as those implemented by at least block 1504 of FIG. 15. In some examples, the data processing circuitry 204 may be instantiated by hardware logic circuitry, which may be implemented by an ASIC, XPU, or the FPGA circuitry 1900 of FIG. 19 configured and/or structured to perform operations corresponding to the machine readable instructions. Additionally or alternatively, the data processing circuitry 204 may be instantiated by any other combination of hardware, software, and/or firmware. For example, the data processing circuitry 204 may be implemented by at least one or more hardware circuits (e.g., processor circuitry, discrete and/or integrated analog and/or digital circuitry, an FPGA, an ASIC, an XPU, a comparator, an operational-amplifier (op-amp), a logic circuit, etc.) configured and/or structured to execute some or all of the machine readable instructions and/or to perform some or all of the operations corresponding to the machine readable instructions without executing software or firmware, but other structures are likewise appropriate.

In some examples, the anomaly detection circuitry 102 includes means for identifying features. For example, the means for identifying features may be implemented by the feature identification circuitry 206. In some examples, the feature identification circuitry 206 may be instantiated by programmable circuitry such as the example programmable circuitry 1712 of FIG. 17. For instance, the feature identification circuitry 206 may be instantiated by the example microprocessor 1800 of FIG. 18 executing machine executable instructions such as those implemented by at least block 1406 of FIG. 14A. In some examples, the feature identification circuitry 206 may be instantiated by hardware logic circuitry, which may be implemented by an ASIC, XPU, or the FPGA circuitry 1900 of FIG. 19 configured and/or structured to perform operations corresponding to the machine readable instructions. Additionally or alternatively, the feature identification circuitry 206 may be instantiated by any other combination of hardware, software, and/or firmware. For example, the feature identification circuitry 206 may be implemented by at least one or more hardware circuits (e.g., processor circuitry, discrete and/or integrated analog and/or digital circuitry, an FPGA, an ASIC, an XPU, a comparator, an operational-amplifier (op-amp), a logic circuit, etc.) configured and/or structured to execute some or all of the machine readable instructions and/or to perform some or all of the operations corresponding to the machine readable instructions without executing software or firmware, but other structures are likewise appropriate.

In some examples, the anomaly detection circuitry 102 includes means for selecting hyperparameters. For example, the means for selecting hyperparameters may be implemented by the hyperparameter selection circuitry 208. In some examples, the hyperparameter selection circuitry 208 may be instantiated by programmable circuitry such as the example programmable circuitry 1712 of FIG. 17. For instance, the hyperparameter selection circuitry 208 may be instantiated by the example microprocessor 1800 of FIG. 18 executing machine executable instructions such as those implemented by at least blocks 1508, 1510 of FIG. 15. In some examples, the hyperparameter selection circuitry 208 may be instantiated by hardware logic circuitry, which may be implemented by an ASIC, XPU, or the FPGA circuitry 1900 of FIG. 19 configured and/or structured to perform operations corresponding to the machine readable instructions. Additionally or alternatively, the hyperparameter selection circuitry 208 may be instantiated by any other combination of hardware, software, and/or firmware. For example, the hyperparameter selection circuitry 208 may be implemented by at least one or more hardware circuits (e.g., processor circuitry, discrete and/or integrated analog and/or digital circuitry, an FPGA, an ASIC, an XPU, a comparator, an operational-amplifier (op-amp), a logic circuit, etc.) configured and/or structured to execute some or all of the machine readable instructions and/or to perform some or all of the operations corresponding to the machine readable instructions without executing software or firmware, but other structures are likewise appropriate.

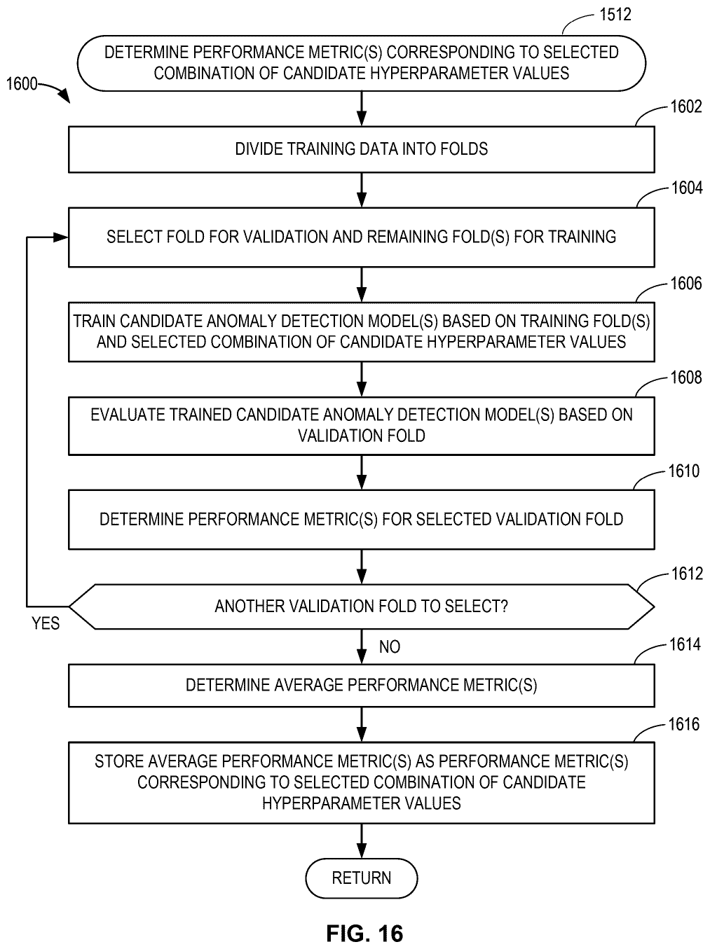

In some examples, the anomaly detection circuitry 102 includes means for training. For example, the means for training may be implemented by the model training circuitry 210. In some examples, the model training circuitry 210 may be instantiated by programmable circuitry such as the example programmable circuitry 1712 of FIG. 17. For instance, the model training circuitry 210 may be instantiated by the example microprocessor 1800 of FIG. 18 executing machine executable instructions such as those implemented by at least blocks 1506, 1512, 1514, 1516, 1518, 1522, 1524, 1526 of FIG. 15 and/or blocks 1602, 1604, 1606, 1608, 1610, 1612, 1614, 1616 of FIG. 16. In some examples, the model training circuitry 210 may be instantiated by hardware logic circuitry, which may be implemented by an ASIC, XPU, or the FPGA circuitry 1900 of FIG. 19 configured and/or structured to perform operations corresponding to the machine readable instructions. Additionally or alternatively, the model training circuitry 210 may be instantiated by any other combination of hardware, software, and/or firmware. For example, the model training circuitry 210 may be implemented by at least one or more hardware circuits (e.g., processor circuitry, discrete and/or integrated analog and/or digital circuitry, an FPGA, an ASIC, an XPU, a comparator, an operational-amplifier (op-amp), a logic circuit, etc.) configured and/or structured to execute some or all of the machine readable instructions and/or to perform some or all of the operations corresponding to the machine readable instructions without executing software or firmware, but other structures are likewise appropriate.

In some examples, the anomaly detection circuitry 102 includes means for executing. For example, the means for executing may be implemented by the model execution circuitry 212. In some examples, the model execution circuitry 212 may be instantiated by programmable circuitry such as the example programmable circuitry 1712 of FIG. 17. For instance, the model execution circuitry 212 may be instantiated by the example microprocessor 1800 of FIG. 18 executing machine executable instructions such as those implemented by at least blocks 1408, 1410 of FIG. 14A and/or block 1520 of FIG. 15. In some examples, the model execution circuitry 212 may be instantiated by hardware logic circuitry, which may be implemented by an ASIC, XPU, or the FPGA circuitry 1900 of FIG. 19 configured and/or structured to perform operations corresponding to the machine readable instructions. Additionally or alternatively, the model execution circuitry 212 may be instantiated by any other combination of hardware, software, and/or firmware. For example, the model execution circuitry 212 may be implemented by at least one or more hardware circuits (e.g., processor circuitry, discrete and/or integrated analog and/or digital circuitry, an FPGA, an ASIC, an XPU, a comparator, an operational-amplifier (op-amp), a logic circuit, etc.) configured and/or structured to execute some or all of the machine readable instructions and/or to perform some or all of the operations corresponding to the machine readable instructions without executing software or firmware, but other structures are likewise appropriate.

In some examples, the anomaly detection circuitry 102 includes means for generating a report. For example, the means for generating a report may be implemented by the report generation circuitry 214. In some examples, the report generation circuitry 214 may be instantiated by programmable circuitry such as the example programmable circuitry 1712 of FIG. 17. For instance, the report generation circuitry 214 may be instantiated by the example microprocessor 1800 of FIG. 18 executing machine executable instructions such as those implemented by at least block 1412 of FIG. 14A and/or blocks 1454, 1456, 1458 of FIG. 14B. In some examples, the report generation circuitry 214 may be instantiated by hardware logic circuitry, which may be implemented by an ASIC, XPU, or the FPGA circuitry 1900 of FIG. 19 configured and/or structured to perform operations corresponding to the machine readable instructions. Additionally or alternatively, the report generation circuitry 214 may be instantiated by any other combination of hardware, software, and/or firmware. For example, the report generation circuitry 214 may be implemented by at least one or more hardware circuits (e.g., processor circuitry, discrete and/or integrated analog and/or digital circuitry, an FPGA, an ASIC, an XPU, a comparator, an operational-amplifier (op-amp), a logic circuit, etc.) configured and/or structured to execute some or all of the machine readable instructions and/or to perform some or all of the operations corresponding to the machine readable instructions without executing software or firmware, but other structures are likewise appropriate.

While an example manner of implementing the anomaly detection circuitry 102 of FIG. 1 is illustrated in FIG. 2, one or more of the elements, processes, and/or devices illustrated in FIG. 2 may be combined, divided, re-arranged, omitted, eliminated, and/or implemented in any other way. Further, the example data interface circuitry 202, the example data processing circuitry 204, the example feature identification circuitry 206, the example hyperparameter selection circuitry 208, the example model training circuitry 210, the example model execution circuitry 212, the example report generation circuitry 214, the example database 216, and/or, more generally, the example anomaly detection circuitry 102 of FIG. 2, may be implemented by hardware alone or by hardware in combination with software and/or firmware. Thus, for example, any of the example data interface circuitry 202, the example data processing circuitry 204, the example feature identification circuitry 206, the example hyperparameter selection circuitry 208, the example model training circuitry 210, the example model execution circuitry 212, the example report generation circuitry 214, the example database 216, and/or, more generally, the example anomaly detection circuitry 102, could be implemented by programmable circuitry in combination with machine readable instructions (e.g., firmware or software), processor circuitry, analog circuit(s), digital circuit(s), logic circuit(s), programmable processor(s), programmable microcontroller(s), graphics processing unit(s) (GPU(s)), digital signal processor(s) (DSP(s)), ASIC(s), programmable logic device(s) (PLD(s)), and/or field programmable logic device(s) (FPLD(s)) such as FPGAs. Further still, the example anomaly detection circuitry 102 of FIG. 2 may include one or more elements, processes, and/or devices in addition to, or instead of, those illustrated in FIG. 2, and/or may include more than one of any or all of the illustrated elements, processes and devices.

Flowchart(s) representative of example machine readable instructions, which may be executed by programmable circuitry to implement and/or instantiate the anomaly detection circuitry 102 of FIG. 2 and/or representative of example operations which may be performed by programmable circuitry to implement and/or instantiate the anomaly detection circuitry 102 of FIG. 2, are shown in FIGS. 14A, 14B, 15, and/or 16. The machine readable instructions may be one or more executable programs or portion(s) of one or more executable programs for execution by programmable circuitry such as the programmable circuitry 1712 shown in the example processor platform 1700 discussed below in connection with FIG. 17 and/or may be one or more function(s) or portion(s) of functions to be performed by the example programmable circuitry (e.g., an FPGA) discussed below in connection with FIGS. 18 and/or 19. In some examples, the machine readable instructions cause an operation, a task, etc., to be carried out and/or performed in an automated manner in the real world. As used herein, “automated” means without human involvement.

The program may be embodied in instructions (e.g., software and/or firmware) stored on one or more non-transitory computer readable and/or machine readable storage medium such as cache memory, a magnetic-storage device or disk (e.g., a floppy disk, a Hard Disk Drive (HDD), etc.), an optical-storage device or disk (e.g., a Blu-ray disk, a Compact Disk (CD), a Digital Versatile Disk (DVD), etc.), a Redundant Array of Independent Disks (RAID), a register, ROM, a solid-state drive (SSD), SSD memory, non-volatile memory (e.g., electrically erasable programmable read-only memory (EEPROM), flash memory, etc.), volatile memory (e.g., Random Access Memory (RAM) of any type, etc.), and/or any other storage device or storage disk. The instructions of the non-transitory computer readable and/or machine readable medium may program and/or be executed by programmable circuitry located in one or more hardware devices, but the entire program and/or parts thereof could alternatively be executed and/or instantiated by one or more hardware devices other than the programmable circuitry and/or embodied in dedicated hardware. The machine readable instructions may be distributed across multiple hardware devices and/or executed by two or more hardware devices (e.g., a server and a client hardware device). For example, the client hardware device may be implemented by an endpoint client hardware device (e.g., a hardware device associated with a human and/or machine user) or an intermediate client hardware device gateway (e.g., a radio access network (RAN)) that may facilitate communication between a server and an endpoint client hardware device. Similarly, the non-transitory computer readable storage medium may include one or more mediums. Further, although the example program is described with reference to the flowchart(s) illustrated in FIGS. 14A, 14B, 15, and/or 16, many other methods of implementing the example anomaly detection circuitry 102 may alternatively be used. For example, the order of execution of the blocks of the flowchart(s) may be changed, and/or some of the blocks described may be changed, eliminated, or combined. Additionally or alternatively, any or all of the blocks of the flow chart may be implemented by one or more hardware circuits (e.g., processor circuitry, discrete and/or integrated analog and/or digital circuitry, an FPGA, an ASIC, a comparator, an operational-amplifier (op-amp), a logic circuit, etc.) structured to perform the corresponding operation without executing software or firmware. The programmable circuitry may be distributed in different network locations and/or local to one or more hardware devices (e.g., a single-core processor (e.g., a single core CPU), a multi-core processor (e.g., a multi-core CPU, an XPU, etc.)). For example, the programmable circuitry may be a CPU and/or an FPGA located in the same package (e.g., the same integrated circuit (IC) package or in two or more separate housings), one or more processors in a single machine, multiple processors distributed across multiple servers of a server rack, multiple processors distributed across one or more server racks, etc., and/or any combination(s) thereof.

The machine readable instructions described herein may be stored in one or more of a compressed format, an encrypted format, a fragmented format, a compiled format, an executable format, a packaged format, etc. Machine readable instructions as described herein may be stored as data (e.g., computer-readable data, machine-readable data, one or more bits (e.g., one or more computer-readable bits, one or more machine-readable bits, etc.), a bitstream (e.g., a computer-readable bitstream, a machine-readable bitstream, etc.), etc.) or a data structure (e.g., as portion(s) of instructions, code, representations of code, etc.) that may be utilized to create, manufacture, and/or produce machine executable instructions. For example, the machine readable instructions may be fragmented and stored on one or more storage devices, disks and/or computing devices (e.g., servers) located at the same or different locations of a network or collection of networks (e.g., in the cloud, in edge devices, etc.). The machine readable instructions may require one or more of installation, modification, adaptation, updating, combining, supplementing, configuring, decryption, decompression, unpacking, distribution, reassignment, compilation, etc., in order to make them directly readable, interpretable, and/or executable by a computing device and/or other machine. For example, the machine readable instructions may be stored in multiple parts, which are individually compressed, encrypted, and/or stored on separate computing devices, wherein the parts when decrypted, decompressed, and/or combined form a set of computer-executable and/or machine executable instructions that implement one or more functions and/or operations that may together form a program such as that described herein.

In another example, the machine readable instructions may be stored in a state in which they may be read by programmable circuitry, but require addition of a library (e.g., a dynamic link library (DLL)), a software development kit (SDK), an application programming interface (API), etc., in order to execute the machine-readable instructions on a particular computing device or other device. In another example, the machine readable instructions may need to be configured (e.g., settings stored, data input, network addresses recorded, etc.) before the machine readable instructions and/or the corresponding program(s) can be executed in whole or in part. Thus, machine readable, computer readable and/or machine readable media, as used herein, may include instructions and/or program(s) regardless of the particular format or state of the machine readable instructions and/or program(s).

The machine readable instructions described herein can be represented by any past, present, or future instruction language, scripting language, programming language, etc. For example, the machine readable instructions may be represented using any of the following languages: C, C++, Java, C#, Perl, Python, JavaScript, HyperText Markup Language (HTML), Structured Query Language (SQL), Swift, etc.

As mentioned above, the example operations of FIGS. 14A, 14B, 15, and/or 16 may be implemented using executable instructions (e.g., computer readable and/or machine readable instructions) stored on one or more non-transitory computer readable and/or machine readable media. As used herein, the terms non-transitory computer readable medium, non-transitory computer readable storage medium, non-transitory machine readable medium, and/or non-transitory machine readable storage medium are expressly defined to include any type of computer readable storage device and/or storage disk and to exclude propagating signals and to exclude transmission media. Examples of such non-transitory computer readable medium, non-transitory computer readable storage medium, non-transitory machine readable medium, and/or non-transitory machine readable storage medium include optical storage devices, magnetic storage devices, an HDD, a flash memory, a read-only memory (ROM), a CD, a DVD, a cache, a RAM of any type, a register, and/or any other storage device or storage disk in which information is stored for any duration (e.g., for extended time periods, permanently, for brief instances, for temporarily buffering, and/or for caching of the information). As used herein, the terms “non-transitory computer readable storage device” and “non-transitory machine readable storage device” are defined to include any physical (mechanical, magnetic and/or electrical) hardware to retain information for a time period, but to exclude propagating signals and to exclude transmission media. Examples of non-transitory computer readable storage devices and/or non-transitory machine readable storage devices include random access memory of any type, read only memory of any type, solid state memory, flash memory, optical discs, magnetic disks, disk drives, and/or redundant array of independent disks (RAID) systems. As used herein, the term “device” refers to physical structure such as mechanical and/or electrical equipment, hardware, and/or circuitry that may or may not be configured by computer readable instructions, machine readable instructions, etc., and/or manufactured to execute computer-readable instructions, machine-readable instructions, etc.

FIG. 14A is a flowchart representative of example machine readable instructions and/or example operations 1400 that may be executed, instantiated, and/or performed by programmable circuitry to detect anomalies in price series data (e.g., the price series data 106 of FIG. 1). The example machine-readable instructions and/or the example operations 1400 of FIG. 14A begin at block 1401, at which the example anomaly detection circuitry 102 of FIGS. 1 and/or 2 monitors one or more example report transmission requests. For example, the example data interface circuitry 202 of FIG. 2 monitors the report transmission request(s) received by the anomaly detection circuitry 102 to transmit and/or output a report (e.g., a price exception report, a reduced report). Monitoring of the report transmission request(s) is described further below in connection with FIG. 14B.

At block 1402, the example anomaly detection circuitry 102 accesses and/or generates one or more example anomaly detection models (e.g., the anomaly detection model(s) 308 of FIG. 3). In some examples, the example data interface circuitry 202 of FIG. 2 accesses the anomaly detection model(s) 308 from the database 216 of FIG. 2. In some examples, the anomaly detection circuitry 102 generates and/or trains the anomaly detection model(s) 308 based on the historical data 110 of FIG. 1 (e.g., as described in connection with FIGS. 15 and/or 16 below).

At block 1404, the example anomaly detection circuitry 102 accesses the price series data 106 of FIG. 1. For example, the data interface circuitry 202 can access the price series data 106 from the database 216, and/or can access and/or obtain the price series data 106 from one or more devices and/or from a cloud-based environment (e.g., via the network 108 of FIG. 1). In some examples, the price series data 106 includes one or more example features (e.g., retailer prices, reference prices, retailer descriptions, reference descriptions) corresponding to one or more products, retailers, geographic regions, etc.

At block 1406, the example anomaly detection circuitry 102 identifies and/or determines one or more feature(s) (and/or a subset of the features) represented in the price series data 106. For example, the feature identification circuitry 206 can identify first feature(s) from the features included in the price series data 106 (e.g., the retailer prices, the reference prices, the retailer descriptions, the reference descriptions, etc.). In some examples, the feature identification circuitry 206 determines and/or calculates one or more second features based on the first features. In some examples, the feature identification circuitry 206 selects and/or determines the subset of features including the first differences between the factored prices and the retailer prices, the dummy variables, the first binary values representative of whether a correction factor has been applied, the second binary values representative of whether a correction factor has been suggested, the fourth binary values representative of whether the description(s) include numerical value(s), the ratios between the factored and reference prices, the retailer prices, the reference prices, and the factored prices.

At block 1408, the example anomaly detection circuitry 102 executes the anomaly detection model(s) based on the identified features (e.g., the selected subset of features). For example, the example model execution circuitry 212 of FIG. 2 provides the subset of features as input to the anomaly detection model(s), and executes the anomaly detection model(s) 308 based on the subset of features.

At block 1410, the example anomaly detection circuitry 102 detects, based on a result of the execution of the anomaly detection model(s), one or more anomalous prices in the price series data 106. For example, as a result of the execution, the model execution circuitry 212 outputs predicted labels corresponding to respective data samples represented in the price series data 106, where the predicted labels indicate whether the respective data samples are predicted to be anomalous or non-anomalous. In some examples, the model execution circuitry 212 detects and/or identifies the anomalous price(s) corresponding to one(s) of the data samples predicted to be anomalous (e.g., corresponding to a predicted label of anomalous).

At block 1412, the example anomaly detection circuitry 102 generates one or more example reports (e.g., the report(s) 218 of FIG. 2) based on the detected anomalous price(s). For example, the example report generation circuitry 214 of FIG. 2 generates the report(s) 218 including the one(s) of the data samples corresponding to a predicted label of anomalous. In some examples, the report generation circuitry 214 outputs the report(s) 218 for presentation (e.g., by the user device 104 of FIG. 1).

At block 1414, the example anomaly detection circuitry 102 determines whether there is additional price series data to analyze. For example, the data interface circuitry 202 determines whether additional price series data is accessible and/or available from the database 216 and/or from one or more devices (e.g., via the network 108 of FIG. 1). In response to the data interface circuitry 202 determining that there is additional price series data to analyze (e.g., block 1414 returns a result of YES), control returns to block 1404. Alternatively, in response to the data interface circuitry 202 determines that there is no additional price series data to analyze (e.g., block 1414 returns a result of NO), control proceeds to block 1416.

At block 1416, the example anomaly detection circuitry 102 determines whether to continue monitoring. For example, the data interface circuitry 202 determines whether to continue monitoring for additional report transmission request(s) received at the anomaly detection circuitry 102. In response to the data interface circuitry 202 determining to continue monitoring (e.g., block 1416 returns a result of YES), control returns to block 1401. Alternatively, in response to the data interface circuitry 202 determining not to continue monitoring (e.g., block 1416 returns a result of NO), control ends.

FIG. 14B is a flowchart representative of example machine readable instructions and/or example operations 1450 that may be executed, instantiated, and/or performed by programmable circuitry to monitor report transmission requests (e.g., in connection with block 1401 of FIG. 14A). The example machine-readable instructions and/or the example operations 1450 of FIG. 14B begin at block 1401, at which the example anomaly detection circuitry 102 of FIGS. 1 and/or 2 determines whether one or more report transmission requests have been received. For example, the example data interface circuitry 202 of FIG. 2 determines whether the report transmission request(s) have been received and/or obtained (e.g., via user input to the user device 104 of FIG. 1, via a network communication to the user device 104, etc.). In some examples, the report transmission request(s) indicate to the anomaly detection circuitry 102 that a reduced report (e.g., the report(s) 218 of FIG. 2) is to be transmitted (e.g., to another user device, to a cloud-based environment, etc.). In response to the data interface circuitry 202 determining that no transmission requests have been received (e.g., block 1452 returns a result of NO), control returns to block 1452 until a report transmission request is received. Alternatively, in response to the data interface circuitry 202 determining that one or more report transmission requests have been received (e.g., block 1452 returns a result of YES), control proceeds to block 1454.

At block 1454, the example anomaly detection circuitry 102 determines whether one or more reduced reports are available. For example, the example report generation circuitry 214 of FIG. 2 determines that the reduced report(s) are available when the report(s) 218 of FIG. 2 have been generated based on the price series data 106, where a first number of data samples represented in the report(s) 218 is less than a second number of data samples represented in the price series data 106 (e.g., in one or more price exception reports included in the price series data 106). In response to the report generation circuitry 214 determining that the reduced report(s) are available (e.g., block 1454 returns a result of YES), control proceeds to block 1456. Alternatively, in response to the report generation circuitry 214 determining that no reduced report(s) are available (e.g., block 1456 returns a result of NO), control proceeds to block 1458.

At block 1456, the example anomaly detection circuitry 102 permits (e.g., causes, enables) transmission of the reduced report(s) (e.g., the report(s) 218 of FIG. 2). For example, the report generation circuitry 214 permits and/or enables transmission (e.g., via the network 108 of FIG. 1) of the report(s) 218 (e.g., to one or more devices, cloud-based environments, etc.) for presentation and/or storage.

At block 1458, the example anomaly detection circuitry 102 blocks (e.g., prohibits, prevents) transmission of the price series data 106. For example, the report generation circuitry 214 blocks transmission of the one or more price exception reports included in the price series data 106 when the reduced report(s) (e.g., the report(s) 218) have not been generated and/or are otherwise unavailable. As a result, the anomaly detection circuitry 102 reduces bandwidth consumption associated with transmission of the price series data 106. In some examples, control returns to block 1402 of FIG. 14A to generate the reduced report(s) based on the price series data 106.

FIG. 15 is a flowchart representative of example machine readable instructions and/or example operations 1500 that may be executed, instantiated, and/or performed by programmable circuitry to generate and/or train one or more example anomaly detection models (e.g., the anomaly detection model(s) of FIG. 3). The example machine-readable instructions and/or the example operations 1500 of FIG. 15 begin at block 1502, at which the example anomaly detection circuitry 102 of FIGS. 1 and/or 2 accesses the example historical data 110 of FIG. 1. For example, the example data interface circuitry 202 can access the historical data 110 from the database 216, and/or can access and/or obtain the historical data 110 from one or more devices and/or from a cloud-based environment (e.g., via the network 108 of FIG. 1). In some examples, the historical data 110 includes historical (e.g., previously collected) data samples and ground truth labels determined for respective ones of the historical data samples.

At block 1504, the example anomaly detection circuitry 102 performs pre-processing of the historical data 110. For example, the example data processing circuitry 204 of FIG. 2 can process the historical data 110 to remove duplicate data samples from the historical data 110, and/or can determine one or more example features of the historical data 110.

At block 1506, the example anomaly detection circuitry 102 selects a first portion of the historical data 110 as training data and a second portion of the historical data 110 as test data. For example, the example model training circuitry 210 of FIG. 2 selects the first portion (e.g., 80%) of the historical data 110 for the training dataset 302 of FIG. 3 and selects the second portion (e.g., 20%) of the historical data 110 for the testing dataset 304 of FIG. 3.

At block 1508, the example anomaly detection circuitry 102 selects and/or determines example candidate hyperparameter values. For example, the example hyperparameter selection circuitry 208 of FIG. 2 selects and/or determines the candidate hyperparameter values that can be used for respective hyperparameters of the anomaly detection model(s) 308. In some examples, the hyperparameters include a threshold depth (e.g., a maximum depth) associated with a binary decision tree of the anomaly detection model(s) 308, a threshold (e.g., minimum) number of samples to split an internal node of the binary decision tree, a threshold (e.g., minimum) number of samples corresponding to a leaf node of the binary decision tree, and/or weights associated with respective classes (e.g., anomalous and non-anomalous) to be predicted and/or output based on the binary decision tree.

At block 1510, the example anomaly detection circuitry 102 selects a combination of the candidate hyperparameter values for evaluation. For example, the hyperparameter selection circuitry 208 selects the combination of the candidate hyperparameter values from a grid of the candidate hyperparameter values representative of some (e.g., all) possible combinations of the candidate hyperparameter values. In some examples, the hyperparameter selection circuitry 208 selects different combinations of the candidate hyperparameter values for subsequent iterations of the process of block 1512.

At block 1512, the example anomaly detection circuitry 102 determines one or more example performance metrics corresponding to the selected combination of the candidate hyperparameter values. For example, the model training circuitry 210 determines the performance metric(s) by training a binary decision tree based on the selected combination of the candidate hyperparameter values and the first portion of the historical data 110 (e.g., the training dataset 302), and executing the trained binary decision tree based on the second portion of the historical data 110 (e.g., the testing dataset 304). In some examples, determination of the performance metric(s) corresponding to the selected combination of the candidate hyperparameter values is described further below in connection with FIG. 16.

At block 1514, the example anomaly detection circuitry 102 determines whether there are one or more additional combinations of the candidate hyperparameter values to evaluate. For example, in response to the model training circuitry 210 determining that there are additional combination(s) of the candidate hyperparameter values to be evaluated (e.g., block 1514 returns a result of YES), control returns to block 1510. Alternatively, in response to the model training circuitry 210 determining that there are no additional combinations of the candidate hyperparameter values to be evaluated (e.g., block 1514 returns a result of NO), control proceeds to block 1516.

At block 1516, the example anomaly detection circuitry 102 selects final hyperparameter values based on the determined performance metric(s). For example, the model training circuitry 210 compares the performance metric(s) (e.g., an average recall metric) determined for respective one(s) of the combinations of candidate hyperparameter values, and selects one of the combinations associated with a highest performance metric (e.g., relative to other one(s) of the combinations) as the final hyperparameter values.

At block 1518, the example anomaly detection circuitry 102 trains the anomaly detection model(s) 308 based on the training data (e.g., the training dataset 302) and the final hyperparameter values. For example, the model training circuitry 210 generates a binary decision tree having the final hyperparameter values, and trains the binary decision tree based on the training dataset 302 to generate the anomaly detection model(s) 308.

At block 1520, the example anomaly detection circuitry 102 evaluates the trained anomaly detection model(s) 308 based on the test data (e.g., the testing dataset 304). For example, the model execution circuitry 212 of FIG. 2 can execute the trained anomaly detection model(s) 308 based on the testing dataset 304 to output predicted labels corresponding to respective ones of the historical data samples represented in the testing dataset 304. In some examples, the model training circuitry 210 compares the predicted labels to the corresponding ground truth labels to determine respective numbers of true positives, false positives, false negatives, and true negatives output and/or predicted by the trained anomaly detection model(s) 308.

At block 1522, the example anomaly detection circuitry 102 determines one or more example performance metrics corresponding to the trained anomaly detection model(s) 308. For example, the model training circuitry 210 determines at least one of an accuracy metric, a precision metric, or a recall metric based on the numbers of true positives, false positives, false negatives, and/or true negatives output based on the anomaly detection model(s) 308.

At block 1524, the example anomaly detection circuitry 102 determines whether the performance metric(s) satisfy example performance criteria. For example, the model training circuitry 210 determines whether the accuracy metric satisfies an example accuracy threshold, the precision metric satisfies an example precision metric, and/or the recall metric satisfies an example recall metric. In response to the model training circuitry 210 determining that the performance metric(s) do not satisfy the performance criteria (e.g., block 1524 returns a result of NO), control returns to block 1508. Alternatively, in response to the model training circuitry 210 determining that the performance metric(s) satisfy the performance criteria (e.g., block 1524 returns a result of YES), control proceeds to block 1526.

At block 1526, the example anomaly detection circuitry 102 causes storage of the trained anomaly detection model(s) 308. For example, the model training circuitry 210 can cause storage of the trained anomaly detection model(s) 308 in the example database 216 of FIG. 2, where the anomaly detection model(s) 308 are accessible by the model execution circuitry 212.

FIG. 16 is a flowchart representative of example machine readable instructions and/or example operations 1600 that may be executed, instantiated, and/or performed by programmable circuitry to determine example performance metrics corresponding to a selected combination of candidate hyperparameter values (e.g., in connection with block 1512 of FIG. 15). The example machine-readable instructions and/or the example operations 1600 of FIG. 16 begin at block 1602, at which the example anomaly detection circuitry 102 of FIGS. 1 and/or 2 divides the training data (e.g., the training dataset 302 of FIG. 3) into example folds 406. For example, the example model training circuitry 210 of FIG. 2 divides the training dataset 302 into the folds 406 corresponding to respective different durations (e.g., time periods, weeks, etc.), where the folds 406 include one(s) of the historical data samples corresponding to the respective durations.

At block 1604, the example anomaly detection circuitry 102 selects one of the folds 406 as a validation fold, and selects remaining one(s) of the folds 406 as training folds. For example, the model training circuitry 210 selects a first one of the folds 406 (e.g., a fifth fold 406E) as the validation fold, and selects second one(s) of the folds 406 (e.g., a first fold 406A, a second fold 406B, a third fold 406C, and a fourth fold 406D) as the training folds. In some examples, the model training circuitry 210 selects a different one of the folds 406 as the validation fold for successive iterations of the process of blocks 1606-1610.

At block 1606, the example anomaly detection circuitry 102 trains one or more candidate anomaly detection models based on the training folds and the selected combination of the candidate hyperparameter values. For example, the model training circuitry 210 generates a binary decision tree having the selected combination of the candidate hyperparameter values, and trains the binary decision tree based on the training folds to generate the candidate anomaly detection model(s).

At block 1608, the example anomaly detection circuitry 102 evaluates the trained candidate anomaly detection model(s) based on the validation fold. For example, the model training circuitry 210 can execute the candidate anomaly detection model(s) based on the validation fold to output predicted labels corresponding to respective ones of the historical data samples represented in the validation fold. In some examples, the model training circuitry 210 compares the predicted labels to the corresponding ground truth labels to determine respective numbers of true positives, false positives, false negatives, and true negatives output and/or predicted by the trained candidate anomaly detection model(s).

At block 1610, the example anomaly detection circuitry 102 determines one or more example performance metrics corresponding to the selected validation fold. For example, the model training circuitry 210 determines at least one of an accuracy metric, a precision metric, or a recall metric based on the numbers of true positives, false positives, false negatives, and/or true negatives output based on execution of the candidate anomaly detection model(s) based on the selected validation fold.

At block 1612, the example anomaly detection circuitry 102 determines whether there is an additional fold to select and/or evaluate as a validation fold. In response to the model training circuitry 210 determining that there is an additional fold to select as a validation fold (e.g., block 1612 returns a result of YES), control returns to block 1604. Alternatively, in response to the model training circuitry 210 determining that there are no additional folds to select as a validation fold (e.g., block 1612 returns a result of NO), control proceeds to block 1614.

At block 1614, the example anomaly detection circuitry 102 determines one or more average performance metrics for the selected combination of the candidate hyperparameter values. For example, the anomaly detection circuitry 102 determines and/or accesses the performance metric(s) determined for the respective validation folds, and determines an average of the performance metrics (e.g., an average recall metric).

At block 1616, the example anomaly detection circuitry 102 stores the average performance metric(s) as the performance metric(s) (e.g., final candidate performance metric(s)) corresponding to the selected combination of the candidate hyperparameter values. In some examples, the process returns and/or proceeds to block 1514 of FIG. 15, where the average performance metric(s) are determined and/or compared for different combinations of the candidate hyperparameter values.

FIG. 17 is a block diagram of an example programmable circuitry platform 1700 structured to execute and/or instantiate the example machine-readable instructions and/or the example operations of FIGS. 14A, 14B, 15, and/or 16 to implement the anomaly detection circuitry 102 of FIG. 2. The programmable circuitry platform 1700 can be, for example, a server, a personal computer, a workstation, a self-learning machine (e.g., a neural network), a mobile device (e.g., a cell phone, a smart phone, a tablet such as an iPad™), a personal digital assistant (PDA), an Internet appliance, a DVD player, a CD player, a digital video recorder, a Blu-ray player, a gaming console, a personal video recorder, a set top box, a headset (e.g., an augmented reality (AR) headset, a virtual reality (VR) headset, etc.) or other wearable device, or any other type of computing and/or electronic device.

The programmable circuitry platform 1700 of the illustrated example includes programmable circuitry 1712. The programmable circuitry 1712 of the illustrated example is hardware. For example, the programmable circuitry 1712 can be implemented by one or more integrated circuits, logic circuits, FPGAs, microprocessors, CPUs, GPUs, DSPs, and/or microcontrollers from any desired family or manufacturer. The programmable circuitry 1712 may be implemented by one or more semiconductor based (e.g., silicon based) devices. In this example, the programmable circuitry 1712 implements the example data interface circuitry 202, the example data processing circuitry 204, the example feature identification circuitry 206, the example hyperparameter selection circuitry 208, the example model training circuitry 210, the example model execution circuitry 212, the example report generation circuitry 214, and the example database 216.

The programmable circuitry 1712 of the illustrated example includes a local memory 1713 (e.g., a cache, registers, etc.). The programmable circuitry 1712 of the illustrated example is in communication with main memory 1714, 1716, which includes a volatile memory 1714 and a non-volatile memory 1716, by a bus 1718. The volatile memory 1714 may be implemented by Synchronous Dynamic Random Access Memory (SDRAM), Dynamic Random Access Memory (DRAM), RAMBUS® Dynamic Random Access Memory (RDRAM®), and/or any other type of RAM device. The non-volatile memory 1716 may be implemented by flash memory and/or any other desired type of memory device. Access to the main memory 1714, 1716 of the illustrated example is controlled by a memory controller 1717. In some examples, the memory controller 1717 may be implemented by one or more integrated circuits, logic circuits, microcontrollers from any desired family or manufacturer, or any other type of circuitry to manage the flow of data going to and from the main memory 1714, 1716.

The programmable circuitry platform 1700 of the illustrated example also includes interface circuitry 1720. The interface circuitry 1720 may be implemented by hardware in accordance with any type of interface standard, such as an Ethernet interface, a universal serial bus (USB) interface, a Bluetooth® interface, a near field communication (NFC) interface, a Peripheral Component Interconnect (PCI) interface, and/or a Peripheral Component Interconnect Express (PCIe) interface.

In the illustrated example, one or more input devices 1722 are connected to the interface circuitry 1720. The input device(s) 1722 permit(s) a user (e.g., a human user, a machine user, etc.) to enter data and/or commands into the programmable circuitry 1712. The input device(s) 1722 can be implemented by, for example, an audio sensor, a microphone, a camera (still or video), a keyboard, a button, a mouse, a touchscreen, a trackpad, a trackball, an isopoint device, and/or a voice recognition system.

One or more output devices 1724 are also connected to the interface circuitry 1720 of the illustrated example. The output device(s) 1724 can be implemented, for example, by display devices (e.g., a light emitting diode (LED), an organic light emitting diode (OLED), a liquid crystal display (LCD), a cathode ray tube (CRT) display, an in-place switching (IPS) display, a touchscreen, etc.), a tactile output device, a printer, and/or speaker. The interface circuitry 1720 of the illustrated example, thus, typically includes a graphics driver card, a graphics driver chip, and/or graphics processor circuitry such as a GPU.

The interface circuitry 1720 of the illustrated example also includes a communication device such as a transmitter, a receiver, a transceiver, a modem, a residential gateway, a wireless access point, and/or a network interface to facilitate exchange of data with external machines (e.g., computing devices of any kind) by a network 1726. The communication can be by, for example, an Ethernet connection, a digital subscriber line (DSL) connection, a telephone line connection, a coaxial cable system, a satellite system, a beyond-line-of-sight wireless system, a line-of-sight wireless system, a cellular telephone system, an optical connection, etc.

The programmable circuitry platform 1700 of the illustrated example also includes one or more mass storage discs or devices 1728 to store firmware, software, and/or data. Examples of such mass storage discs or devices 1728 include magnetic storage devices (e.g., floppy disk, drives, HDDs, etc.), optical storage devices (e.g., Blu-ray disks, CDs, DVDs, etc.), RAID systems, and/or solid-state storage discs or devices such as flash memory devices and/or SSDs.

The machine readable instructions 1732, which may be implemented by the machine readable instructions of FIGS. 14A, 14B, 15, and/or 16, may be stored in the mass storage device 1728, in the volatile memory 1714, in the non-volatile memory 1716, and/or on at least one non-transitory computer readable storage medium such as a CD or DVD which may be removable.

FIG. 18 is a block diagram of an example implementation of the programmable circuitry 1712 of FIG. 17. In this example, the programmable circuitry 1712 of FIG. 17 is implemented by a microprocessor 1800. For example, the microprocessor 1800 may be a general-purpose microprocessor (e.g., general-purpose microprocessor circuitry). The microprocessor 1800 executes some or all of the machine-readable instructions of the flowcharts of FIGS. 14A, 14B, 15, and/or 16 to effectively instantiate the circuitry of FIG. 2 as logic circuits to perform operations corresponding to those machine readable instructions. In some such examples, the circuitry of FIG. 2 is instantiated by the hardware circuits of the microprocessor 1800 in combination with the machine-readable instructions. For example, the microprocessor 1800 may be implemented by multi-core hardware circuitry such as a CPU, a DSP, a GPU, an XPU, etc. Although it may include any number of example cores 1802 (e.g., 1 core), the microprocessor 1800 of this example is a multi-core semiconductor device including N cores. The cores 1802 of the microprocessor 1800 may operate independently or may cooperate to execute machine readable instructions. For example, machine code corresponding to a firmware program, an embedded software program, or a software program may be executed by one of the cores 1802 or may be executed by multiple ones of the cores 1802 at the same or different times. In some examples, the machine code corresponding to the firmware program, the embedded software program, or the software program is split into threads and executed in parallel by two or more of the cores 1802. The software program may correspond to a portion or all of the machine readable instructions and/or operations represented by the flowcharts of FIGS. 14A, 14B, 15, and/or 16.

The cores 1802 may communicate by a first example bus 1804. In some examples, the first bus 1804 may be implemented by a communication bus to effectuate communication associated with one(s) of the cores 1802. For example, the first bus 1804 may be implemented by at least one of an Inter-Integrated Circuit (I2C) bus, a Serial Peripheral Interface (SPI) bus, a PCI bus, or a PCIe bus. Additionally or alternatively, the first bus 1804 may be implemented by any other type of computing or electrical bus. The cores 1802 may obtain data, instructions, and/or signals from one or more external devices by example interface circuitry 1806. The cores 1802 may output data, instructions, and/or signals to the one or more external devices by the interface circuitry 1806. Although the cores 1802 of this example include example local memory 1820 (e.g., Level 1 (L1) cache that may be split into an L1 data cache and an L1 instruction cache), the microprocessor 1800 also includes example shared memory 1810 that may be shared by the cores (e.g., Level 2 (L2 cache)) for high-speed access to data and/or instructions. Data and/or instructions may be transferred (e.g., shared) by writing to and/or reading from the shared memory 1810. The local memory 1820 of each of the cores 1802 and the shared memory 1810 may be part of a hierarchy of storage devices including multiple levels of cache memory and the main memory (e.g., the main memory 1714, 1716 of FIG. 17). Typically, higher levels of memory in the hierarchy exhibit lower access time and have smaller storage capacity than lower levels of memory. Changes in the various levels of the cache hierarchy are managed (e.g., coordinated) by a cache coherency policy.

Each core 1802 may be referred to as a CPU, DSP, GPU, etc., or any other type of hardware circuitry. Each core 1802 includes control unit circuitry 1814, arithmetic and logic (AL) circuitry (sometimes referred to as an ALU) 1816, a plurality of registers 1818, the local memory 1820, and a second example bus 1822. Other structures may be present. For example, each core 1802 may include vector unit circuitry, single instruction multiple data (SIMD) unit circuitry, load/store unit (LSU) circuitry, branch/jump unit circuitry, floating-point unit (FPU) circuitry, etc. The control unit circuitry 1814 includes semiconductor-based circuits structured to control (e.g., coordinate) data movement within the corresponding core 1802. The AL circuitry 1816 includes semiconductor-based circuits structured to perform one or more mathematic and/or logic operations on the data within the corresponding core 1802. The AL circuitry 1816 of some examples performs integer based operations. In other examples, the AL circuitry 1816 also performs floating-point operations. In yet other examples, the AL circuitry 1816 may include first AL circuitry that performs integer-based operations and second AL circuitry that performs floating-point operations. In some examples, the AL circuitry 1816 may be referred to as an Arithmetic Logic Unit (ALU).

The registers 1818 are semiconductor-based structures to store data and/or instructions such as results of one or more of the operations performed by the AL circuitry 1816 of the corresponding core 1802. For example, the registers 1818 may include vector register(s), SIMD register(s), general-purpose register(s), flag register(s), segment register(s), machine-specific register(s), instruction pointer register(s), control register(s), debug register(s), memory management register(s), machine check register(s), etc. The registers 1818 may be arranged in a bank as shown in FIG. 18. Alternatively, the registers 1818 may be organized in any other arrangement, format, or structure, such as by being distributed throughout the core 1802 to shorten access time. The second bus 1822 may be implemented by at least one of an I2C bus, a SPI bus, a PCI bus, or a PCIe bus.

Each core 1802 and/or, more generally, the microprocessor 1800 may include additional and/or alternate structures to those shown and described above. For example, one or more clock circuits, one or more power supplies, one or more power gates, one or more cache home agents (CHAs), one or more converged/common mesh stops (CMSs), one or more shifters (e.g., barrel shifter(s)) and/or other circuitry may be present. The microprocessor 1800 is a semiconductor device fabricated to include many transistors interconnected to implement the structures described above in one or more integrated circuits (ICs) contained in one or more packages.

The microprocessor 1800 may include and/or cooperate with one or more accelerators (e.g., acceleration circuitry, hardware accelerators, etc.). In some examples, accelerators are implemented by logic circuitry to perform certain tasks more quickly and/or efficiently than can be done by a general-purpose processor. Examples of accelerators include ASICs and FPGAs such as those discussed herein. A GPU, DSP and/or other programmable device can also be an accelerator. Accelerators may be on-board the microprocessor 1800, in the same chip package as the microprocessor 1800 and/or in one or more separate packages from the microprocessor 1800.

FIG. 19 is a block diagram of another example implementation of the programmable circuitry 1712 of FIG. 17. In this example, the programmable circuitry 1712 is implemented by FPGA circuitry 1900. For example, the FPGA circuitry 1900 may be implemented by an FPGA. The FPGA circuitry 1900 can be used, for example, to perform operations that could otherwise be performed by the example microprocessor 1800 of FIG. 18 executing corresponding machine readable instructions. However, once configured, the FPGA circuitry 1900 instantiates the operations and/or functions corresponding to the machine readable instructions in hardware and, thus, can often execute the operations/functions faster than they could be performed by a general-purpose microprocessor executing the corresponding software.

More specifically, in contrast to the microprocessor 1800 of FIG. 18 described above (which is a general purpose device that may be programmed to execute some or all of the machine readable instructions represented by the flowchart(s) of FIGS. 14A, 14B, 15, and/or 16 but whose interconnections and logic circuitry are fixed once fabricated), the FPGA circuitry 1900 of the example of FIG. 19 includes interconnections and logic circuitry that may be configured, structured, programmed, and/or interconnected in different ways after fabrication to instantiate, for example, some or all of the operations/functions corresponding to the machine readable instructions represented by the flowchart(s) of FIGS. 14A, 14B, 15, and/or 16. In particular, the FPGA circuitry 1900 may be thought of as an array of logic gates, interconnections, and switches. The switches can be programmed to change how the logic gates are interconnected by the interconnections, effectively forming one or more dedicated logic circuits (unless and until the FPGA circuitry 1900 is reprogrammed). The configured logic circuits enable the logic gates to cooperate in different ways to perform different operations on data received by input circuitry. Those operations may correspond to some or all of the instructions (e.g., the software and/or firmware) represented by the flowchart(s) of FIGS. 14A, 14B, 15, and/or 16. As such, the FPGA circuitry 1900 may be configured and/or structured to effectively instantiate some or all of the operations/functions corresponding to the machine readable instructions of the flowchart(s) of FIGS. 14A, 14B, 15, and/or 16 as dedicated logic circuits to perform the operations/functions corresponding to those software instructions in a dedicated manner analogous to an ASIC. Therefore, the FPGA circuitry 1900 may perform the operations/functions corresponding to the some or all of the machine readable instructions of FIGS. 14A, 14B, 15, and/or 16 faster than the general-purpose microprocessor can execute the same.

In the example of FIG. 19, the FPGA circuitry 1900 is configured and/or structured in response to being programmed (and/or reprogrammed one or more times) based on a binary file. In some examples, the binary file may be compiled and/or generated based on instructions in a hardware description language (HDL) such as Lucid, Very High Speed Integrated Circuits (VHSIC) Hardware Description Language (VHDL), or Verilog. For example, a user (e.g., a human user, a machine user, etc.) may write code or a program corresponding to one or more operations/functions in an HDL; the code/program may be translated into a low-level language as needed; and the code/program (e.g., the code/program in the low-level language) may be converted (e.g., by a compiler, a software application, etc.) into the binary file. In some examples, the FPGA circuitry 1900 of FIG. 19 may access and/or load the binary file to cause the FPGA circuitry 1900 of FIG. 19 to be configured and/or structured to perform the one or more operations/functions. For example, the binary file may be implemented by a bit stream (e.g., one or more computer-readable bits, one or more machine-readable bits, etc.), data (e.g., computer-readable data, machine-readable data, etc.), and/or machine-readable instructions accessible to the FPGA circuitry 1900 of FIG. 19 to cause configuration and/or structuring of the FPGA circuitry 1900 of FIG. 19, or portion(s) thereof.

In some examples, the binary file is compiled, generated, transformed, and/or otherwise output from a uniform software platform utilized to program FPGAs. For example, the uniform software platform may translate first instructions (e.g., code or a program) that correspond to one or more operations/functions in a high-level language (e.g., C, C++, Python, etc.) into second instructions that correspond to the one or more operations/functions in an HDL. In some such examples, the binary file is compiled, generated, and/or otherwise output from the uniform software platform based on the second instructions. In some examples, the FPGA circuitry 1900 of FIG. 19 may access and/or load the binary file to cause the FPGA circuitry 1900 of FIG. 19 to be configured and/or structured to perform the one or more operations/functions. For example, the binary file may be implemented by a bit stream (e.g., one or more computer-readable bits, one or more machine-readable bits, etc.), data (e.g., computer-readable data, machine-readable data, etc.), and/or machine-readable instructions accessible to the FPGA circuitry 1900 of FIG. 19 to cause configuration and/or structuring of the FPGA circuitry 1900 of FIG. 19, or portion(s) thereof.

The FPGA circuitry 1900 of FIG. 19, includes example input/output (I/O) circuitry 1902 to obtain and/or output data to/from example configuration circuitry 1904 and/or external hardware 1906. For example, the configuration circuitry 1904 may be implemented by interface circuitry that may obtain a binary file, which may be implemented by a bit stream, data, and/or machine-readable instructions, to configure the FPGA circuitry 1900, or portion(s) thereof. In some such examples, the configuration circuitry 1904 may obtain the binary file from a user, a machine (e.g., hardware circuitry (e.g., programmable or dedicated circuitry) that may implement an Artificial Intelligence/Machine Learning (AI/ML) model to generate the binary file), etc., and/or any combination(s) thereof). In some examples, the external hardware 1906 may be implemented by external hardware circuitry. For example, the external hardware 1906 may be implemented by the microprocessor 1800 of FIG. 18.

The FPGA circuitry 1900 also includes an array of example logic gate circuitry 1908, a plurality of example configurable interconnections 1910, and example storage circuitry 1912. The logic gate circuitry 1908 and the configurable interconnections 1910 are configurable to instantiate one or more operations/functions that may correspond to at least some of the machine readable instructions of FIGS. 14A, 14B, 15, and/or 16 and/or other desired operations. The logic gate circuitry 1908 shown in FIG. 19 is fabricated in blocks or groups. Each block includes semiconductor-based electrical structures that may be configured into logic circuits. In some examples, the electrical structures include logic gates (e.g., And gates, Or gates, Nor gates, etc.) that provide basic building blocks for logic circuits. Electrically controllable switches (e.g., transistors) are present within each of the logic gate circuitry 1908 to enable configuration of the electrical structures and/or the logic gates to form circuits to perform desired operations/functions. The logic gate circuitry 1908 may include other electrical structures such as look-up tables (LUTs), registers (e.g., flip-flops or latches), multiplexers, etc.

The configurable interconnections 1910 of the illustrated example are conductive pathways, traces, vias, or the like that may include electrically controllable switches (e.g., transistors) whose state can be changed by programming (e.g., using an HDL instruction language) to activate or deactivate one or more connections between one or more of the logic gate circuitry 1908 to program desired logic circuits.

The storage circuitry 1912 of the illustrated example is structured to store result(s) of the one or more of the operations performed by corresponding logic gates. The storage circuitry 1912 may be implemented by registers or the like. In the illustrated example, the storage circuitry 1912 is distributed amongst the logic gate circuitry 1908 to facilitate access and increase execution speed.

The example FPGA circuitry 1900 of FIG. 19 also includes example dedicated operations circuitry 1914. In this example, the dedicated operations circuitry 1914 includes special purpose circuitry 1916 that may be invoked to implement commonly used functions to avoid the need to program those functions in the field. Examples of such special purpose circuitry 1916 include memory (e.g., DRAM) controller circuitry, PCIe controller circuitry, clock circuitry, transceiver circuitry, memory, and multiplier-accumulator circuitry. Other types of special purpose circuitry may be present. In some examples, the FPGA circuitry 1900 may also include example general purpose programmable circuitry 1918 such as an example CPU 1920 and/or an example DSP 1922. Other general purpose programmable circuitry 1918 may additionally or alternatively be present such as a GPU, an XPU, etc., that can be programmed to perform other operations.

Although FIGS. 18 and 19 illustrate two example implementations of the programmable circuitry 1712 of FIG. 17, many other approaches are contemplated. For example, FPGA circuitry may include an on-board CPU, such as one or more of the example CPU 1920 of FIG. 18. Therefore, the programmable circuitry 1712 of FIG. 17 may additionally be implemented by combining at least the example microprocessor 1800 of FIG. 18 and the example FPGA circuitry 1900 of FIG. 19. In some such hybrid examples, one or more cores 1802 of FIG. 18 may execute a first portion of the machine readable instructions represented by the flowchart(s) of FIGS. 14A, 14B, 15, and/or 16 to perform first operation(s)/function(s), the FPGA circuitry 1900 of FIG. 19 may be configured and/or structured to perform second operation(s)/function(s) corresponding to a second portion of the machine readable instructions represented by the flowcharts of FIG. 14A, 14B, 15, and/or 16, and/or an ASIC may be configured and/or structured to perform third operation(s)/function(s) corresponding to a third portion of the machine readable instructions represented by the flowcharts of FIGS. 14A, 14B, 15, and/or 16.

It should be understood that some or all of the circuitry of FIG. 2 may, thus, be instantiated at the same or different times. For example, same and/or different portion(s) of the microprocessor 1800 of FIG. 18 may be programmed to execute portion(s) of machine-readable instructions at the same and/or different times. In some examples, same and/or different portion(s) of the FPGA circuitry 1900 of FIG. 19 may be configured and/or structured to perform operations/functions corresponding to portion(s) of machine-readable instructions at the same and/or different times.

In some examples, some or all of the circuitry of FIG. 2 may be instantiated, for example, in one or more threads executing concurrently and/or in series. For example, the microprocessor 1800 of FIG. 18 may execute machine readable instructions in one or more threads executing concurrently and/or in series. In some examples, the FPGA circuitry 1900 of FIG. 19 may be configured and/or structured to carry out operations/functions concurrently and/or in series. Moreover, in some examples, some or all of the circuitry of FIG. 2 may be implemented within one or more virtual machines and/or containers executing on the microprocessor 1800 of FIG. 18.

In some examples, the programmable circuitry 1712 of FIG. 17 may be in one or more packages. For example, the microprocessor 1800 of FIG. 18 and/or the FPGA circuitry 1900 of FIG. 19 may be in one or more packages. In some examples, an XPU may be implemented by the programmable circuitry 1712 of FIG. 17, which may be in one or more packages. For example, the XPU may include a CPU (e.g., the microprocessor 1800 of FIG. 18, the CPU 1920 of FIG. 19, etc.) in one package, a DSP (e.g., the DSP 1922 of FIG. 19) in another package, a GPU in yet another package, and an FPGA (e.g., the FPGA circuitry 1900 of FIG. 19) in still yet another package.

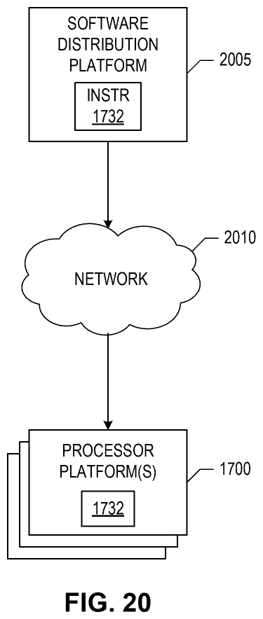

A block diagram illustrating an example software distribution platform 2005 to distribute software such as the example machine readable instructions 1732 of FIG. 17 to other hardware devices (e.g., hardware devices owned and/or operated by third parties from the owner and/or operator of the software distribution platform) is illustrated in FIG. 20. The example software distribution platform 2005 may be implemented by any computer server, data facility, cloud service, etc., capable of storing and transmitting software to other computing devices. The third parties may be customers of the entity owning and/or operating the software distribution platform 2005. For example, the entity that owns and/or operates the software distribution platform 2005 may be a developer, a seller, and/or a licensor of software such as the example machine readable instructions 1732 of FIG. 17. The third parties may be consumers, users, retailers, OEMs, etc., who purchase and/or license the software for use and/or re-sale and/or sub-licensing. In the illustrated example, the software distribution platform 2005 includes one or more servers and one or more storage devices. The storage devices store the machine-readable instructions 1732, which may correspond to the example machine readable instructions of FIGS. 14A, 14B, 15, and/or 16, as described above. The one or more servers of the example software distribution platform 2005 are in communication with an example network 2010, which may correspond to any one or more of the Internet and/or any of the example networks described above. In some examples, the one or more servers are responsive to requests to transmit the software to a requesting party as part of a commercial transaction. Payment for the delivery, sale, and/or license of the software may be handled by the one or more servers of the software distribution platform and/or by a third party payment entity. The servers enable purchasers and/or licensors to download the machine-readable instructions 1732 from the software distribution platform 2005. For example, the software, which may correspond to the example machine readable instructions of FIGS. 14A, 14B, 15, and/or 16, may be downloaded to the example programmable circuitry platform 1700, which is to execute the machine-readable instructions 1732 to implement the anomaly detection circuitry 102. In some examples, one or more servers of the software distribution platform 2005 periodically offer, transmit, and/or force updates to the software (e.g., the example machine readable instructions 1732 of FIG. 17) to ensure improvements, patches, updates, etc., are distributed and applied to the software at the end user devices. Although referred to as software above, the distributed “software” could alternatively be firmware.

“Including” and “comprising” (and all forms and tenses thereof) are used herein to be open ended terms. Thus, whenever a claim employs any form of “include” or “comprise” (e.g., comprises, includes, comprising, including, having, etc.) as a preamble or within a claim recitation of any kind, it is to be understood that additional elements, terms, etc., may be present without falling outside the scope of the corresponding claim or recitation. As used herein, when the phrase “at least” is used as the transition term in, for example, a preamble of a claim, it is open-ended in the same manner as the term “comprising” and “including” are open ended. The term “and/or” when used, for example, in a form such as A, B, and/or C refers to any combination or subset of A, B, C such as (1) A alone, (2) B alone, (3) C alone, (4) A with B, (5) A with C, (6) B with C, or (7) A with B and with C. As used herein in the context of describing structures, components, items, objects and/or things, the phrase “at least one of A and B” is intended to refer to implementations including any of (1) at least one A, (2) at least one B, or (3) at least one A and at least one B. Similarly, as used herein in the context of describing structures, components, items, objects and/or things, the phrase “at least one of A or B” is intended to refer to implementations including any of (1) at least one A, (2) at least one B, or (3) at least one A and at least one B. As used herein in the context of describing the performance or execution of processes, instructions, actions, activities, etc., the phrase “at least one of A and B” is intended to refer to implementations including any of (1) at least one A, (2) at least one B, or (3) at least one A and at least one B. Similarly, as used herein in the context of describing the performance or execution of processes, instructions, actions, activities, etc., the phrase “at least one of A or B” is intended to refer to implementations including any of (1) at least one A, (2) at least one B, or (3) at least one A and at least one B.

As used herein, singular references (e.g., “a”, “an”, “first”, “second”, etc.) do not exclude a plurality. The term “a” or “an” object, as used herein, refers to one or more of that object. The terms “a” (or “an”), “one or more”, and “at least one” are used interchangeably herein. Furthermore, although individually listed, a plurality of means, elements, or actions may be implemented by, e.g., the same entity or object. Additionally, although individual features may be included in different examples or claims, these may possibly be combined, and the inclusion in different examples or claims does not imply that a combination of features is not feasible and/or advantageous.

As used herein, unless otherwise stated, the term “above” describes the relationship of two parts relative to Earth. A first part is above a second part, if the second part has at least one part between Earth and the first part. Likewise, as used herein, a first part is “below” a second part when the first part is closer to the Earth than the second part. As noted above, a first part can be above or below a second part with one or more of: other parts therebetween, without other parts therebetween, with the first and second parts touching, or without the first and second parts being in direct contact with one another.

As used in this patent, stating that any part (e.g., a layer, film, area, region, or plate) is in any way on (e.g., positioned on, located on, disposed on, or formed on, etc.) another part, indicates that the referenced part is either in contact with the other part, or that the referenced part is above the other part with one or more intermediate part(s) located therebetween.

As used herein, connection references (e.g., attached, coupled, connected, and joined) may include intermediate members between the elements referenced by the connection reference and/or relative movement between those elements unless otherwise indicated. As such, connection references do not necessarily infer that two elements are directly connected and/or in fixed relation to each other. As used herein, stating that any part is in “contact” with another part is defined to mean that there is no intermediate part between the two parts.

Unless specifically stated otherwise, descriptors such as “first,” “second,” “third,” etc., are used herein without imputing or otherwise indicating any meaning of priority, physical order, arrangement in a list, and/or ordering in any way, but are merely used as labels and/or arbitrary names to distinguish elements for ease of understanding the disclosed examples. In some examples, the descriptor “first” may be used to refer to an element in the detailed description, while the same element may be referred to in a claim with a different descriptor such as “second” or “third.” In such instances, it should be understood that such descriptors are used merely for identifying those elements distinctly within the context of the discussion (e.g., within a claim) in which the elements might, for example, otherwise share a same name.

As used herein, “approximately” and “about” modify their subjects/values to recognize the potential presence of variations that occur in real world applications. For example, “approximately” and “about” may modify dimensions that may not be exact due to manufacturing tolerances and/or other real world imperfections as will be understood by persons of ordinary skill in the art. For example, “approximately” and “about” may indicate such dimensions may be within a tolerance range of +/−10% unless otherwise specified herein.

As used herein “substantially real time” refers to occurrence in a near instantaneous manner recognizing there may be real world delays for computing time, transmission, etc. Thus, unless otherwise specified, “substantially real time” refers to real time +1 second.

As used herein, the phrase “in communication,” including variations thereof, encompasses direct communication and/or indirect communication through one or more intermediary components, and does not require direct physical (e.g., wired) communication and/or constant communication, but rather additionally includes selective communication at periodic intervals, scheduled intervals, aperiodic intervals, and/or one-time events.

As used herein, “programmable circuitry” is defined to include (i) one or more special purpose electrical circuits (e.g., an application specific circuit (ASIC)) structured to perform specific operation(s) and including one or more semiconductor-based logic devices (e.g., electrical hardware implemented by one or more transistors), and/or (ii) one or more general purpose semiconductor-based electrical circuits programmable with instructions to perform specific functions(s) and/or operation(s) and including one or more semiconductor-based logic devices (e.g., electrical hardware implemented by one or more transistors). Examples of programmable circuitry include programmable microprocessors such as Central Processor Units (CPUs) that may execute first instructions to perform one or more operations and/or functions, Field Programmable Gate Arrays (FPGAs) that may be programmed with second instructions to cause configuration and/or structuring of the FPGAs to instantiate one or more operations and/or functions corresponding to the first instructions, Graphics Processor Units (GPUs) that may execute first instructions to perform one or more operations and/or functions, Digital Signal Processors (DSPs) that may execute first instructions to perform one or more operations and/or functions, XPUs, Network Processing Units (NPUs) one or more microcontrollers that may execute first instructions to perform one or more operations and/or functions and/or integrated circuits such as Application Specific Integrated Circuits (ASICs). For example, an XPU may be implemented by a heterogeneous computing system including multiple types of programmable circuitry (e.g., one or more FPGAs, one or more CPUs, one or more GPUs, one or more NPUs, one or more DSPs, etc., and/or any combination(s) thereof), and orchestration technology (e.g., application programming interface(s) (API(s)) that may assign computing task(s) to whichever one(s) of the multiple types of programmable circuitry is/are suited and available to perform the computing task(s).

As used herein integrated circuit/circuitry is defined as one or more semiconductor packages containing one or more circuit elements such as transistors, capacitors, inductors, resistors, current paths, diodes, etc. For example an integrated circuit may be implemented as one or more of an ASIC, an FPGA, a chip, a microchip, programmable circuitry, a semiconductor substrate coupling multiple circuit elements, a system on chip (SoC), etc.

From the foregoing, it will be appreciated that example systems, apparatus, articles of manufacture, and methods have been disclosed to detect anomalies in price series data. Examples disclosed herein train and/or generate example anomaly detection model(s) based on binary decision trees, and execute the anomaly detection model(s) based on a subset of features from the price series data. As a result of execution, the anomaly detection model(s) output predicted labels corresponding to respective data samples in the price series data, where the predicted labels indicate whether the corresponding data samples are predicted to be anomalous or non-anomalous. Examples disclosed herein can generate an example report (e.g., a reduced report) including one(s) of the data samples corresponding to an anomalous predicted label. As a result, while the price series data includes a first quantity of data samples, the report includes a second quantity of data samples (e.g., less than the first quantity). Advantageously, by reducing the quantity of data samples represented in the report (e.g., compared to the price series data), examples disclosed herein reduce the quantity of samples to be manually reviewed by one or more operators, thus reducing time necessitated for such review. Additionally, disclosed systems, apparatus, articles of manufacture, and methods improve the efficiency of using a computing device by reducing utilization of computer resources (e.g., computer memory and/or bandwidth) for storage and/or transmission of the report (e.g., compared to the price series data). Further, by utilizing a binary decision tree for detection of anomalies, disclosed examples are less computationally intensive compared to other machine learning models and, thus, may be executed using a CPU (e.g., instead of a GPU). Disclosed systems, apparatus, articles of manufacture, and methods are accordingly directed to one or more improvement(s) in the operation of a machine such as a computer or other electronic and/or mechanical device.

Example methods, apparatus, systems, and articles of manufacture to detect anomalies in price series data are disclosed herein. Further examples and combinations thereof include the following:

Example 1 includes an apparatus comprising interface circuitry, machine-readable instructions, and at least one processor circuit to be programmed by the machine-readable instructions to identify features in price series data, the price series data having a first quantity of data samples, execute, based on the identified features, an anomaly detection model to detect anomalies in the price series data, and generate a reduced report including a second quantity of the data samples corresponding to the detected anomalies, the second quantity less than the first quantity, a difference between the first quantity and the second quantity corresponding to an omitted portion of the price series data.

Example 2 includes the apparatus of example 1, wherein the anomalies correspond to unexpected variations between retailer prices and reference prices in the price series data.

Example 3 includes the apparatus of example 1, wherein the features include at least one of (a) a retailer price, (b) a reference price, (c) a first binary value indicative of whether a correction factor has been suggested for the retailer price, (d) a second binary value indicative of whether the correction factor has been applied to the retailer price, (e) a factored price based on the retailer price and the correction factor, (f) a difference between the factored price and the retailer price, (g) a ratio between the factored price and the reference price, (h) a dummy variable corresponding to one or more retailers, or (i) a third binary value indicative of whether a product description associated with the retailer price includes a numerical value.

Example 4 includes the apparatus of example 1, wherein the at least one processor circuit is to train the anomaly detection model based on historical data, the at least one processor circuit to select a training dataset from the historical data, train, based on the training dataset, candidate anomaly detection models for respective combinations of hyperparameter values, select a first combination of the hyperparameter values based on performance metrics corresponding to the candidate anomaly detection models, and train the anomaly detection model based on the first combination of the hyperparameter values.

Example 5 includes the apparatus of example 4, wherein the anomaly detection model corresponds to a binary decision tree, the hyperparameter values corresponding to at least one of (a) a threshold depth associated with the binary decision tree, (b) a first threshold number of samples to split an internal node of the binary decision tree, (c) a second threshold number of samples corresponding to a leaf node of the binary decision tree, or (d) first and second class weights associated with respective first and second classes to be predicted based on the binary decision tree.

Example 6 includes the apparatus of example 5, wherein the first class weight corresponds to the anomalies in the price series data, the second class weight corresponds to non-anomalous data samples in the price series data, the first class weight greater than the second class weight.

Example 7 includes the apparatus of example 1, wherein the omitted portion does not correspond to the detected anomalies.

Example 8 includes the apparatus of example 1, wherein the at least one processor circuit is to cause transmission of the reduced report to a device to at least one of store or cause presentation of the reduced report.

Example 9 includes At least one non-transitory machine-readable medium comprising machine-readable instructions to cause at least one processor circuit to at least identify features in price series data, the price series data having a first quantity of data samples, execute, based on the identified features, an anomaly detection model to detect anomalies in the price series data, and generate a reduced report including a second quantity of the data samples corresponding to the detected anomalies, the second quantity less than the first quantity, a difference between the first quantity and the second quantity corresponding to an omitted portion of the price series data.

Example 10 includes the at least one non-transitory machine-readable medium of example 9, wherein the anomalies correspond to unexpected variations between retailer prices and reference prices in the price series data.

Example 11 includes the at least one non-transitory machine-readable medium of example 9, wherein the features include at least one of (a) a retailer price, (b) a reference price, (c) a first binary value indicative of whether a correction factor has been suggested for the retailer price, (d) a second binary value indicative of whether the correction factor has been applied to the retailer price, (e) a factored price based on the retailer price and the correction factor, (f) a difference between the factored price and the retailer price, (g) a ratio between the factored price and the reference price, (h) a dummy variable corresponding to one or more retailers, or (i) a third binary value indicative of whether a product description associated with the retailer price includes a numerical value.

Example 12 includes the at least one non-transitory machine-readable medium of example 9, wherein the machine-readable instructions are to cause one or more of the at least one processor circuit to train the anomaly detection model based on historical data, the at least one processor circuit to select a training dataset from the historical data, train, based on the training dataset, candidate anomaly detection models for respective combinations of hyperparameter values, select a first combination of the hyperparameter values based on performance metrics corresponding to the candidate anomaly detection models, and train the anomaly detection model based on the first combination of the hyperparameter values.

Example 13 includes the at least one non-transitory machine-readable medium of example 12, wherein the anomaly detection model corresponds to a binary decision tree, the hyperparameter values corresponding to at least one of (a) a threshold depth associated with the binary decision tree, (b) a first threshold number of samples to split an internal node of the binary decision tree, (c) a second threshold number of samples corresponding to a leaf node of the binary decision tree, or (d) first and second class weights associated with respective first and second classes to be predicted based on the binary decision tree.

Example 14 includes the at least one non-transitory machine-readable medium of example 13, wherein the first class weight corresponds to the anomalies in the price series data, the second class weight corresponds to non-anomalous data samples in the price series data, the first class weight greater than the second class weight.

Example 15 includes the at least one non-transitory machine-readable medium of example 9, wherein the omitted portion does not correspond to the detected anomalies.

Example 16 includes the at least one non-transitory machine-readable medium of example 9, wherein the machine-readable instructions are to cause one or more of the at least one processor circuit to cause transmission of the reduced report to a device to at least one of store or cause presentation of the reduced report.

Example 17 includes a method comprising identifying features in price series data, the price series data having a first quantity of data samples, executing, based on the identified features, an anomaly detection model to detect anomalies in the price series data, and generating a reduced report including a second quantity of the data samples corresponding to the detected anomalies, the second quantity less than the first quantity, a difference between the first quantity and the second quantity corresponding to an omitted portion of the price series data.

Example 18 includes the method of example 17, wherein the anomalies correspond to unexpected variations between retailer prices and reference prices in the price series data.

Example 19 includes the method of example 17, wherein the features include at least one of (a) a retailer price, (b) a reference price, (c) a first binary value indicative of whether a correction factor has been suggested for the retailer price, (d) a second binary value indicative of whether the correction factor has been applied to the retailer price, (e) a factored price based on the retailer price and the correction factor, (f) a difference between the factored price and the retailer price, (g) a ratio between the factored price and the reference price, (h) a dummy variable corresponding to one or more retailers, or (i) a third binary value indicative of whether a product description associated with the retailer price includes a numerical value.

Example 20 includes the method of example 17, further including train the anomaly detection model based on historical data by selecting a training dataset from the historical data, training, based on the training dataset, candidate anomaly detection models for respective combinations of hyperparameter values, selecting a first combination of the hyperparameter values based on performance metrics corresponding to the candidate anomaly detection models, and training the anomaly detection model based on the first combination of the hyperparameter values.

Example 21 includes the method of example 20, wherein the anomaly detection model corresponds to a binary decision tree, the hyperparameter values corresponding to at least one of (a) a threshold depth associated with the binary decision tree, (b) a first threshold number of samples to split an internal node of the binary decision tree, (c) a second threshold number of samples corresponding to a leaf node of the binary decision tree, or (d) first and second class weights associated with respective first and second classes to be predicted based on the binary decision tree.

Example 22 includes the method of example 21, wherein the first class weight corresponds to the anomalies in the price series data, the second class weight corresponds to non-anomalous data samples in the price series data, the first class weight greater than the second class weight.

Example 23 includes an apparatus comprising means for identifying features in price series data, the price series data having a first quantity of data samples, means for executing, based on the identified features, an anomaly detection model to detect anomalies in the price series data, and means for generating a reduced report including a second quantity of the data samples corresponding to the detected anomalies, the second quantity less than the first quantity, a difference between the first quantity and the second quantity corresponding to an omitted portion of the price series data.

Example 24 includes the apparatus of example 23, wherein the anomalies correspond to unexpected variations between retailer prices and reference prices in the price series data.

Example 25 includes the apparatus of example 23, wherein the features include at least one of (a) a retailer price, (b) a reference price, (c) a first binary value indicative of whether a correction factor has been suggested for the retailer price, (d) a second binary value indicative of whether the correction factor has been applied to the retailer price, (e) a factored price based on the retailer price and the correction factor, (f) a difference between the factored price and the retailer price, (g) a ratio between the factored price and the reference price, (h) a dummy variable corresponding to one or more retailers, or (i) a third binary value indicative of whether a product description associated with the retailer price includes a numerical value.

Example 26 includes the apparatus of example 23, further including means for selecting a training dataset from historical data, means for training, based on the training dataset, candidate anomaly detection models for respective combinations of hyperparameter values, means for selecting a first combination of the hyperparameter values based on performance metrics corresponding to the candidate anomaly detection models, and means for training the anomaly detection model based on the first combination of the hyperparameter values.

Example 27 includes the apparatus of example 26, wherein the anomaly detection model corresponds to a binary decision tree, the hyperparameter values corresponding to at least one of (a) a threshold depth associated with the binary decision tree, (b) a first threshold number of samples to split an internal node of the binary decision tree, (c) a second threshold number of samples corresponding to a leaf node of the binary decision tree, or (d) first and second class weights associated with respective first and second classes to be predicted based on the binary decision tree.

Example 28 includes the apparatus of example 27, wherein the first class weight corresponds to the anomalies in the price series data, the second class weight corresponds to non-anomalous data samples in the price series data, the first class weight greater than the second class weight.

The following claims are hereby incorporated into this Detailed Description by this reference. Although certain example systems, apparatus, articles of manufacture, and methods have been disclosed herein, the scope of coverage of this patent is not limited thereto. On the contrary, this patent covers all systems, apparatus, articles of manufacture, and methods fairly falling within the scope of the claims of this patent.

1. An apparatus comprising:
interface circuitry;
machine-readable instructions; and
at least one processor circuit to be programmed by the machine-readable instructions to:
identify features in a first quantity of data samples;
train an anomaly detection model based on historical data;
select a combination of hyperparameters based on performance metrics of the anomaly detection model;
retrain the anomaly detection model with the combination of hyperparameters;
execute, based on the identified features, the retrained anomaly detection model to detect anomalies in the first quantity of data samples;
segregate a second quantity of the data samples corresponding to the detected anomalies, the second quantity less than the first quantity;
prohibit network transmission of the combined first quantity and second quantity of the data samples to a computing device, the prohibited network transmission corresponding to a first bandwidth consumption; and
permit network transmission of the second quantity of the data samples to the computing device, the network transmission of the second quantity of the data samples corresponding to a second bandwidth consumption less than the first bandwidth consumption.

2. The apparatus of claim 1, wherein the anomalies correspond to variations between retailer prices and reference prices in the price series first data samples.

3. The apparatus of claim 1, wherein the features include at least one of (a) a retailer price, (b) a reference price, (c) a first binary value indicative of whether a correction factor has been suggested for the retailer price, (d) a second binary value indicative of whether the correction factor has been applied to the retailer price, (e) a factored price based on the retailer price and the correction factor, (f) a difference between the factored price and the retailer price, (g) a ratio between the factored price and the reference price, (h) a dummy variable corresponding to one or more retailers, or (i) a third binary value indicative of whether a product description associated with the retailer price includes a numerical value.

4. (canceled)

5. The apparatus of claim 1, wherein the anomaly detection model corresponds to a binary decision tree, the combination of hyperparameters corresponding to at least one of (a) a threshold depth associated with the binary decision tree, (b) a first threshold number of samples to split an internal node of the binary decision tree, (c) a second threshold number of samples corresponding to a leaf node of the binary decision tree, or (d) first and second class weights associated with respective first and second classes to be predicted based on the binary decision tree.

6. The apparatus of claim 5, wherein the first class weight corresponds to the anomalies in price series data, the second class weights corresponding to non-anomalous data samples in the price series data, the first class weights greater than the second class weights.

7. The apparatus of claim 1, wherein a difference between the first quantity of the data samples and the second quantity of the data samples corresponds to non-anomalous data samples.

8. The apparatus of claim 1, wherein one or more of the at least one processor circuit is to cause transmission of a reduced report associated with the second quantity of the data samples to the computing device, the transmission to cause at least one of storage of the reduced report or presentation of the reduced report.

9. At least one non-transitory machine-readable medium comprising machine-readable instructions to cause at least one processor circuit to at least:
identify features in a first quantity of data samples;
train an anomaly detection model based on historical data;
select a combination of hyperparameters based on performance metrics of the anomaly detection model;
retrain the anomaly detection model with the combination of hyperparameters;
execute, based on the identified features, the retrained anomaly detection model to detect anomalies in the first quantity of data samples;
segregate a second quantity of the data samples corresponding to the detected anomalies, the second quantity less than the first quantity;
prohibit network transmission of the combined first quantity and second quantity of the data samples to a computing device, the prohibited network transmission corresponding to a first bandwidth consumption; and
permit network transmission of the second quantity of the data samples to the computing device, the network transmission of the second quantity of the data samples corresponding to a second bandwidth consumption less than the first bandwidth consumption.

10. The at least one non-transitory machine-readable medium of claim 9, wherein the anomalies correspond to variations between retailer prices and reference prices in the first data samples.

11. The at least one non-transitory machine-readable medium of claim 9, wherein the features include at least one of (a) a retailer price, (b) a reference price, (c) a first binary value indicative of whether a correction factor has been suggested for the retailer price, (d) a second binary value indicative of whether the correction factor has been applied to the retailer price, (e) a factored price based on the retailer price and the correction factor, (f) a difference between the factored price and the retailer price, (g) a ratio between the factored price and the reference price, (h) a dummy variable corresponding to one or more retailers, or (i) a third binary value indicative of whether a product description associated with the retailer price includes a numerical value.

12. (canceled)

13. The at least one non-transitory machine-readable medium of claim 9, wherein the anomaly detection model corresponds to a binary decision tree, the combination of hyperparameters corresponding to at least one of (a) a threshold depth associated with the binary decision tree, (b) a first threshold number of samples to split an internal node of the binary decision tree, (c) a second threshold number of samples corresponding to a leaf node of the binary decision tree, or (d) first and second class weights associated with respective first and second classes to be predicted based on the binary decision tree.

14. The at least one non-transitory machine-readable medium of claim 13, wherein the first class weights correspond to the anomalies in price series data, the second class weights corresponding to non-anomalous data samples in the price series data, the first class weights greater than the second class weights.

15. The at least one non-transitory machine-readable medium of claim 9, wherein the machine-readable instructions are to cause one or more of the at least one processor circuit to identify a difference between the first quantity of the data samples and the second quantity of the data samples, the difference corresponding to non-anomalous data samples.

16. The at least one non-transitory machine-readable medium of claim 9, wherein the machine-readable instructions are to cause one or more of the at least one processor circuit to cause transmission of a reduced report associated with the second quantity of the data samples to the computing device, the transmission to cause at least one of storage of the reduced report or presentation of the reduced report.

17-22. (canceled)

23. An apparatus comprising:
means for identifying features in a first quantity of data samples;
means for training to:
train an anomaly detection model based on historical data;
select a combination of hyperparameters based on performance metrics of the anomaly detection model; and
retrain the anomaly detection model with the combination of hyperparameters;
means for executing to, based on the identified features, execute the retrained anomaly detection model to detect anomalies in the first quantity of data samples; and
means for generating a reduced report to:
segregate a second quantity of the data samples corresponding to the detected anomalies, the second quantity less than the first quantity;
prohibit network transmission of the combined first quantity and second quantity of the data samples to a computing device, the prohibited network transmission corresponding to a first bandwidth consumption; and
permit network transmission of the second quantity of the data samples to the computing device, the network transmission of the second quantity of the data samples corresponding to a second bandwidth consumption less than the first bandwidth consumption.

24. The apparatus of claim 23, wherein the anomalies correspond to variations between retailer prices and reference prices in the price series first data samples.

25. The apparatus of claim 23, wherein the features include at least one of (a) a retailer price, (b) a reference price, (c) a first binary value indicative of whether a correction factor has been suggested for the retailer price, (d) a second binary value indicative of whether the correction factor has been applied to the retailer price, (e) a factored price based on the retailer price and the correction factor, (f) a difference between the factored price and the retailer price, (g) a ratio between the factored price and the reference price, (h) a dummy variable corresponding to one or more retailers, or (i) a third binary value indicative of whether a product description associated with the retailer price includes a numerical value.

26-28. (canceled)
